(19) United States
(12) Patent Application Publication
(10) Pub. No.: US 2011/0052837 A1
(43) Pub. Date: Mar. 3, 2011

(54) THERMOPLASTIC FILM, METHOD FOR PRODUCING SAME, POLARIZER AND LIQUID CRYSTAL DISPLAY DEVICE

(75) Inventors: Kiyokazu HASHIMOTO, Kanagawa (JP); Akihide FUJITA, Kanagawa (JP)

(73) Assignee: FUJIFILM CORPORATION, Tokyo (JP)

(21) Appl. No.: 12/869,131

(22) Filed: Aug. 26, 2010

(30) Foreign Application Priority Data
Aug. 27, 2009 (JP) 2009-196755

(51) Int. Cl. C09K 19/02; B32B 27/00; B32B 7/02; B32B 27/32; B29C 65/40; B29C 47/06; G02B 5/30

(52) U.S. Cl. 428/1.3; 428/411.1; 428/216; 428/523; 264/171.1; 264/173.16; 359/485

(57) ABSTRACT

A thermoplastic film having at least two thermoplastic resin layers laminated on each other, wherein at least the thermoplastic resin layer of the film surface and the thermoplastic resin layer of the film back each have a tilt structure in the thickness direction of the film, and in the plane including the tilt direction of the tilt structure and the film normal line, the sign of the angle, φ between the normal direction of the film surface and the tilt direction differs between the thermoplastic resin layer of the film surface and the thermoplastic resin layer of the film back, and wherein φ is from −90° to 90°.

### CROSS-REFERENCE TO RELATED APPLICATIONS

The present application claims the benefit of priority from Japanese Patent Application No. 196755/2009, filed on Aug. 27, 2010, the contents of which are herein incorporated by reference in their entirety.

### BACKGROUND OF THE INVENTION

1. Field of the Invention

The present invention relates to a method for producing a plastic film. The invention also relates to a plastic film produced according to the production method, and to a polarizer and a liquid crystal display device comprising the film.

2. Description of the Related Art

As a laminate film for optical use, known is a film prepared by laminating a positive birefringent resin and a negative birefringent resin; and the film is used in a liquid crystal display device for improving the viewing angle characteristics of the device (see JP-A 2005-173584 and WO2005/050299). In the laminate film of the type, however, the constitutive resins differ in their physical properties, and therefore the laminate film has a universal problem in that it may curl in one direction and its handlability is poor. Incase where such a conventional laminate film is incorporated in a liquid crystal display device, the viewing angle characteristics of the device change with time, and solving the problem is desired.

On the other hand, known is a liquid crystal display device comprising an optical film that is produced by casting a melt extruded out through a die and sandwiching it between rolls or belts according to a melt casting film formation method, and the viewing angle characteristics of the device comprising the film are improved (See JP-A 2002-365428 and 2007-38646). However, the films produced according the methods described in these patent references are problematic in that, when the film is incorporated into a liquid crystal display device, there occurs a color shift in the device; and solving the problem is desired.

JP-A 6-222213 discloses a method of producing a mono-tilt film by sandwiching a shaped film between plural hot rolls under pressure and imparting a peripheral speed difference to the rolls, and use of the film as an optical compensatory film. However, when the film obtained according to the method described in the patent reference is incorporated in a liquid crystal display device, there also occurs a color shift in the device, and therefore solving the problem is desired.

As in the above, the current condition is that no one has succeeded in obtaining a thermoplastic film laminate which curls little and has good stability with time and which can realize optical compensation with good optical characteristics when incorporated in a liquid crystal display device. In particular, when different types of starting resins are co-extruded according to a conventional method, the resulting laminate film inevitably curls like bimetal, owing to the difference in the dimensional change between the constitutive layers therein.

### SUMMARY OF THE INVENTION

The present invention has been made in consideration of the above-mentioned problems, and its object is to provide a thermoplastic film which curls little and has good stability with time and which realizes good optical compensation when incorporated in a liquid crystal display device.

To solve the above-mentioned problems, the present inventors have assiduously studied and, as a result, have found that, when films having a tilt structure are laminated, then unexpectedly the resulting laminate film can solve the problem of curling. In addition, the inventors have further found that, when two or more thermoplastic resin melt layers are sandwiched at the same time between the members of a sandwiching apparatus and when the sandwiching apparatus is so controlled that a pressure falling within a specific range can be applied between the pressing members, then surprisingly the resulting thermoplastic laminate film curls little and has good stability with time, and in addition, when the laminate film is incorporated in a liquid crystal display device then it realizes good optical compensation in the device.

Specifically, the inventors have found that the production method described below and the film produced according to the production method can solve the above-mentioned problems, and have completed the present invention described below.

[1] A thermoplastic film having at least two thermoplastic resin layers laminated on each other, wherein at least the thermoplastic resin layer of the film surface and the thermoplastic resin layer of the film back each have a tilt structure in the thickness direction of the film, and in the plane including the tilt direction of the tilt structure and the film normal line, the sign of the angle, φ between the normal direction of the film surface and the tilt direction (hereinafter this may be referred to as the alignment angle of the tilt structure) differs between the thermoplastic resin layer of the film surface and the thermoplastic resin layer of the film back, and wherein φ is from −90° to 90°.

[2] The thermoplastic film of [1], wherein the thermoplastic resin layer of the film surface and the thermoplastic resin layer of the film back each have a thickness of at least 2 μm.

[3] The thermoplastic film of [1] or [2], which has an interlayer having a tilt structure in the thickness direction, between the thermoplastic resin layer of the film surface and the thermoplastic resin layer of the film back.

[4] The thermoplastic film of any one of [1] to [3], which satisfies the following formulae (I) and (II):

30nm≦Re[0°]≦300nm (I),

in formula (I), Re[0°] means the in-plane retardation at a wavelength of 550 nm as measured in the film normal direction;

40nm≦γ≦300nm (II),

γ=|Re[+40°]−Re[−40°]| (II)′,

in formula (II)′, Re[+40°] means the in-plane retardation at a wavelength of 550 nm, as measured in the direction tilted by 40° toward the tilt direction side relative to the normal line in the plane including the film tilt direction and the film normal line; and Re[−40°] means the in-plane retardation at a wavelength of 550 nm, as measured in the direction tilted by −40° toward the tilt direction side relative to the normal line in the plane including the film tilt direction and the film normal line.

[5] The thermoplastic film of any one of [1] to [4], wherein the thermoplastic film includes a layer formed of a positive birefringent resin and a layer formed of a negative birefringent resin.

[6] The thermoplastic film of [5], wherein the positive birefringent resin is a cycloolefin resin.

[7] The thermoplastic film of [5] of [6], wherein the negative birefringent resin is a vinyl aromatic resin.

[8] A method for producing a thermoplastic film, which comprises continuously nip-pressing at least two, thermoplastic resin-containing composition melt layers by leading them to run between a first nip-pressing surface and a second nip-pressing surface of a nip-pressing apparatus with applying a pressure of from 30 MPa to 500 MPa to the melt layers.

[9] The method for producing a thermoplastic film of [8], which further includes melt-extruding a thermoplastic resin-containing composition through a die and in which the thus melt-extruded thermoplastic resin melts are led to run between the first nip-pressing surface and the second nip-pressing surface.

[10] The method for producing a thermoplastic film of [8] or [9], wherein the at least two thermoplastic resin melt layers are made to have a melt viscosity difference of from 10 Pa·s to 500 Pa·s therebetween.

[11] The method for producing a thermoplastic film of any one of [8] to [10], wherein the at least two thermoplastic resin melt layers are made to have a temperature difference of from 1° C. to 30° C. therebetween.

[12] The method for producing a thermoplastic film of any one of [8] to [11], at least a positive birefringent resin melt and a negative birefringent resin melt are co-extruded.

[13] The method for producing a thermoplastic film of any one of [8] to [12], wherein the moving speed difference between the first nip-pressing surface and the second nip-pressing surface of the nip-pressing apparatus, as defined according to the following formula, is so controlled as to be from 0.5% to 20%:

Moving Speed Difference(%)=100×{(moving speed of the first nip-pressing surface)−(moving speed of the second nip-pressing surface)}/(moving speed of the first nip-pressing surface).

[14] A thermoplastic film produced according to the thermoplastic film production method of any one of [8] to [13].

[15] A thermoplastic film produced by tenter-stretching the thermoplastic film of any one of [1] to [7] and [14].

[16] The thermoplastic film of [15], of which the mean alignment angle of the in-plane slow axis is 45°±10°.

[17] A polarizer comprising at least one thermoplastic film of any one of [1] to [7] and [14] to [16].

[18] The polarizer of [17], further having a hard coat layer.

[19] A liquid crystal display device comprising at least one of the thermoplastic film of any one of [1] to [7] and [14] to [16], or the polarizer of [17] or [18].

According to the invention, there are provided a thermoplastic laminate film which curls little and has good stability with time and which, when incorporated in a liquid crystal display, realizes good optical compensation; and a method for producing the film.

### BRIEF DESCRIPTION OF THE DRAWINGS

FIG. 1 is a schematic outline view of one example of an IPS-mode liquid crystal display device of the invention.

FIG. 2 is a schematic outline view of one example of an IPS-mode liquid crystal display device of the invention.

FIG. 3 is a schematic outline view of one example of an IPS-mode liquid crystal display device of the invention.

FIG. 4 is a schematic outline view of one example of an IPS-mode liquid crystal display device of the invention.

FIG. 5 is a schematic outline view of one example of an IPS-mode liquid crystal display device of the invention.

FIG. 6 is a schematic outline view of one example of an IPS-mode liquid crystal display device of the invention.

### BEST MODE FOR CARRYING OUT THE INVENTION

The invention is described in more detail hereinunder. In this description, the numerical range expressed by the wording “a number to another number” means the range that falls between the former number indicating the lowermost limit of the range and the latter number indicating the uppermost limit thereof. In the invention, “composition containing a thermoplastic resin” means that the composition contains a thermoplastic resin capable of being melt-casted for film formation in an amount of at least 50%, not substantially containing a polymerizing liquid crystal compound. In the invention, “mass %” means equal to “weight %”, and “% by mass” means equal to “% by weight”.

The embodiment where “the thermoplastic resin layer of the film surface and the thermoplastic resin layer of the film back each have a tilt structure in the thickness direction of the film” in the invention means an embodiment of a thermoplastic film laminate sheet in which the tilt structure of the thermoplastic resin layer on the surface side differs from that of the thermoplastic resin layer on the back side, and this does not mean an embodiment where a polarizing element is sandwiched between a plurality of thermoplastic films each having a different tilt structure. Specifically, the thermoplastic film of the invention is a thermoplastic laminate film not containing a polarizing element, and sticking the thermoplastic film of the invention to a polarizing element gives the polarizer of the invention to be described below.

In the thermoplastic film of the invention, the plural thermoplastic resin layers differ from each other in the composition of the thermoplastic resin constituting the individual layer.

The thermoplastic film of the invention (which may be referred to “film of the invention” hereinafter) is characterized by having at least two thermoplastic resin layers laminated on each other, wherein at least the thermoplastic resin layer of the film surface and the thermoplastic resin layer of the film back each have a tilt structure in the thickness direction of the film, and in the plane including the tilt direction of the tilt structure and the film normal line, the sign of the angle, φ between the normal direction of the film surface and the tilt direction (hereinafter this may be referred to as the alignment angle of the tilt structure) differs between the thermoplastic resin layer of the film surface and the thermoplastic resin layer of the film back, and wherein φ is from −90° to 90°.

### (Tilt Structure)

In the invention, as in the above-mentioned constitution, at least two thermoplastic resin layers are laminated on each other in such a manner that the thermoplastic resin layer of the film surface and the thermoplastic resin layer of the film back each have a tilt structure in the thickness direction of the film as in the above-mentioned constitution, and that, in the plane including the tilt direction of the tilt structure and the film normal line, the sign of the angle, φ between the normal direction of the film surface and the tilt direction differs between the thermoplastic resin layer of the film surface and the thermoplastic resin layer of the film back; and therefore, when the film is incorporated in a liquid crystal display device, it improves the color expression on the liquid crystal display panel seen in oblique directions. Briefly, in a liquid crystal display device (LCD), liquid crystal molecules are aligned between two electrodes for image display based on light blocking/transmission through them. In this, the liquid crystal molecules are aligned between electrodes (even in an IPS-mode liquid crystal cell where the liquid crystal molecules are horizontally aligned between electrodes, the molecules are in slight tilt alignment near the electrodes), and for compensating them, use of a film having a tilt structure is effective. In particular, for the “color shift”, the transmitted light must be compensated throughout the entire wavelength range; and as compared with the compensation for “contrast” described in JP-A 2005-173584, the color shift requires compensation at a higher level. Specifically, for compensation for contrast, the overall quantity of light may be taken into consideration irrespective of the wavelength of light; and for this, the balance of the transmitted light quantity in the entire wavelength range as in the present invention may not be taken into consideration.

For precision optical compensation for correcting the “color shift” in a liquid crystal display device, the compensation must cover the entire tilt angle of LCD. For example, a conventional film having a simple tilt structure in which the tilt angle is constant (for example, the film produced according to the method in JP-A 6-222213) could not compensate continuously varying tilt angles of LCD. As opposed to this but not adhering to any theory, it is anticipated that, in the film of the invention, the constitutive laminate layers may undergo interlayer mixing between the thermoplastic resin layer on the film surface side and the thermoplastic resin layer on the film back side that differ from each other in the alignment angle of the tilt structure, therefore bringing about alignment disturbance, and in this, the tilt structure may partly disappear. Specifically, when the film of the invention, in which the tilt angle varies from the high tilt structure near the surface layer to the non-alignment (tilt angle=0°) near the interface, is incorporated into LCD, it compensates the continuously varying tilt angle of the LCD molecules. This effect is especially useful for compensation of IPS-mode liquid crystal cells. In an IPS mode, the alignment angle is naturally small; and for this, therefore, the low-alignment to non-alignment ingredients in the laminate interface as in the film of the invention are effective.

For promoting the interlayer mixing of thermoplastic resins, the film of the invention is preferably has an embodiment where the thermoplastic resin layer on the film surface side and the thermoplastic resin layer on the film back side that differ from each other in the alignment angle of the tilt structure are adjacent to each other, or an embodiment where an interlayer is provided between the thermoplastic resin layer on the film surface side and the thermoplastic resin layer on the film back side that (more preferably, the interlayer is a layer of a thermoplastic resin, even more preferably a thermoplastic resin layer having a tilt structure in the thickness direction, and especially preferably, the thermoplastic layer for the interlayer is not a polarizing element). In this description, the wording that the thermoplastic resin layers having a tilt structure are “adjacent to” each other includes an embodiment where the thermoplastic resin layers having a tilt structure are directly adjacent to each other, and in addition to this, another embodiment where an adhesive layer is provided between the adjacent thermoplastic resin layers having a tilt structure. This is because the adhesive layer has no influence on the mixing effect since its adhesiveness and elastic intensity are weak.

### (Curling)

The film of the invention curls little. In general, a laminate of thermoplastic resin layers of the same type does not bring about any serious problem of curling; however, in case where different types of thermoplastic resin materials are co-extruded to give a laminate film, then there occurs a difference in the dimensional change between the constitutive layers, for example, the thermoplastic resin layer of which the dimension readily changes in accordance with the environmental change or the like, owing to the difference in the dimensional change rate between the constitutive thermoplastic resins, and as a result, there occurs strain on a different level between the constitutive layers and in accordance with the varying strain, the individual thermoplastic resin layers are given a stress on a different level. For these reasons, like a bimetal, the laminate film may curl in the direction in which the stress is smaller. As opposed to this, the film of the invention is given a tilt structure in the thickness direction thereof, and therefore, though it is a laminate film produced by laminating layers of different types of thermoplastic resins, the film curls little because of the following mechanism.

First, in general, a laminate film may curl owing to the stress (ε×elastic modulus (E)) as generated by the strain (ε) having occurred therein owing to the difference in the dimensional change between the constitutive thermoplastic resin layers.

As opposed to this, in the film of the invention, it may be anticipated that the polymer molecules that constitute the thermoplastic resin may be aligned along the tilt structure therein, and therefore the film has an anisotropic elastic modulus, or that is, the elastic modulus E in the tilt structure direction (tilt direction) is stronger. Accordingly, in the plane including the tilt direction and the film normal line, when the film has a tilt structure where the angle between the normal direction of the film surface and the tilt direction (alignment angle of the tilt structure) is φ, then the in-plane elastic modulus of the film is E×sin φ. Accordingly, it may be anticipated that, in the film of the invention, the stress (ε×E×sin φ) to be generated by the strain could be reduced more as compared with the stress ε×E to be generated by the strain in the conventional laminate film.

Owing to the difference in the in-plane stress between the constitutive thermoplastic resin layers, the film may curl; but the film of the invention comprises thermoplastic resin layers having a tilt structure as so mentioned in the above, and therefore in the film of the invention, the difference in the in-plane stress between the constitutive layers can be reduced low, and the film is kept curling little.

### (Alignment Angle of Tilt Structure)

In the plane including the tilt direction and the film normal line in the film of the invention, preferably, the sign of the angle, φ between the normal direction of the film surface and the tilt direction (alignment angle of the tilt structure) differs between the thermoplastic resin layer of the film surface and the thermoplastic resin layer of the film back, in which φ is from −90° to 90°. Accordingly, the film secures compensation in a broader range of from the tilt in the positive direction to the tilt in the negative direction via the tilt angle φ=0°; and therefore the film of the invention may have an optical compensation capability on a higher level.

Preferably, the film has a positive tilt angle on one film surface (for example, +φa), and has a negative tilt angle (−φb) on the opposite surface. Accordingly, the surface and the back of the film may cancel the stress of each layer that occurs in the direction perpendicular to the film plane owing to the strain, (ε×E×cos(+φa), (ε×E×cos(−φb), and therefore the curling-preventing effect of the film of the invention is more remarkable.

The absolute value of the alignment angle φ of the tilt structure is preferably from 87 degrees to 40 degrees, as measured from the film normal line, more preferably from 86 degrees to 45 degrees, even more preferably from 85 degrees to 50 degrees.

### (Method of Measurement of Alignment Angle of Tilt Structure)

The alignment angle of the tilt structure can be measured as follows: A polarizer is arranged relative to a section of the film of the invention that contains the tilt direction and the thickness direction in the plane thereof, in such a manner that the film plane could be parallel to the absorption axis of the polarizer, and while the polarizer is irradiated with light running in the vertical direction to the surface of the polarizer, the polarizer is rotated in a range of from −90° to 90°. In that condition, the film section is analyzed in sequence from the end on the surface side to the end of the back side thereof in the thickness direction; and the alignment angle is read from the extinction position detected first and the extinction position detected last.

When the rotation angle is 0°, the polarizer is parallel to the film thickness direction of the film surface (the normal direction of the original film surface). The extinction position means the angle at which the film section, as analyzed for the brightness by rotating it in a range of from −90° to 90°, is the darkest.

Concretely, the alignment angle of the tilt structure of the film can be determined, for example, according to the following method.

(1) A film is sampled to give a piece of 5 mm (parallel to the tilt direction)×10 mm (perpendicular to the tilt direction).

(2) The sample film is smoothed with a microtome (Leica's RM2265) on the surface of one end parallel to the tilt direction thereof.

(3) This is cut with a razor (Nisshin EM's single-edge trimming razor), on the surface spaced by 500 μm from the smoothed surface, in parallel to the tilt direction, to prepare a sliced section containing both the tilt direction and the thickness direction in the film plane.

(4) The sliced section is placed between two polarizers set under crossed Nicols, and analyzed with a polarization microscope (Nikon Corporation's Eclipse E600POL) for the extinction change in the film thickness direction (darkest under crossed Nicols). Concretely, the polarizer is arranged in such a manner that the film plane of the sliced section could be parallel to the absorption axis of the polarizer, and change of extinction is observed while the polarizer is rotated at intervals of 1° within a range of from −90° to 90°.

The light source in the polarization microscope analysis is not specifically defined, but is preferably a white light source. The extinction angle determination is not specifically defined. Preferably, based on the images taken with the polarization microscope under crossed Nicols, the extinction angle is determined.

### (Layer Constitution Except Adhesive Layer)

Preferably, in the film of the invention, the thickness of the thermoplastic resin layer of the film surface and that of the thermoplastic resin layer of the film back are at least 2 μm each from the viewpoint of enhancing the storage stability of the optical characteristic (Re) of the film to be described below.

Preferably, in the film of the invention, the thickness of the thermoplastic resin layer of the film surface and that of the thermoplastic resin layer of the film back are at least 2 μm each, more preferably from 3 μm to 150 μm, even more preferably from 5 μm to 80 μm. In the film of the invention, preferably, the thickness of all the constitutive layers falls within the above range. When the thickness is not lower than the lowermost limit of the range, then it may be unnecessary to rapidly change the tilt structure in the thin film, and therefore the tilt structure may change gently. As a result, even a thin layer may not form any stiff structure, and the residual strain resulting from it may be prevented from being changed (released) with time, and therefore Re changes little with time. On the other hand, the thickness of the film is preferably up to the upper limit of the range thereof defined in the invention, since the strain level to be accompanied by film stretching may not be too large and the resulting stress may not be too large, and the curling level may hardly increase.

In case where the film of the invention is a two-layered laminate, it may be composed of two positive birefringent resin layers, or two negative birefringent resin layers, or may be composed of a positive birefringent resin layer and a negative birefringent resin layer. Of those, preferably, the film of the invention is composed of a positive birefringent resin layer and a negative birefringent resin layer, as securing optical compensation in a broader range.

On the other hand, in case where the film of the invention is composed of two positive birefringent resin layers or two negative birefringent resin layers, or that is, in case where the birefringent resin layers constituting the film have the same sign of birefringence, the resins of the two birefringent resin layers may be the same or different. Preferably, the two birefringent resin layers are formed under different conditions with interlayer viscosity difference or interlayer temperature difference, according to the production method of the invention to be described below.

In case where the film of the invention is a three-layered or more multi-layered laminate film, an interlayer is preferably provided between the thermoplastic resin layer of the film surface and the thermoplastic resin layer of the film back.

More preferably, the interlayer is formed of a thermoplastic resin, and even more preferably, the layer is a thermoplastic resin layer having a tilt structure in the thickness direction thereof, and especially preferably, the interlayer is a thermoplastic resin layer except a polarizing element. Specifically, it is desirable that the film of the invention has a tilt structure in at least two of the laminated thermoplastic resin layers therein, more preferably in at least three of them, even more preferably in all of them.

In case where the interlayer between the thermoplastic resin layer of the film surface and the thermoplastic resin layer of the film back has a tilt structure in the thickness direction thereof, the layer constitution is preferably as follows, from the viewpoint of easy optical compensation for liquid crystal cells. The tilt direction of the interlayer in the interface to the thermoplastic resin layer of the film surface is nearly the same as the tilt direction of the thermoplastic resin layer of the film surface; the absolute value of the tilt structure stepwise and gradually decreases from the surface of the laminate film toward the back of the film; the tilt structure once disappears; the absolute value of the tilt structure again stepwise increases; and at the interface between the interlayer and the thermoplastic resin layer of the film back, the tilt direction of the interlayer is nearly the same as the tilt direction of the thermoplastic resin layer of the film back. The embodiment including the interlayer that has the tilt structure constitution of the type can be attained by co-extrusion of three or more layers according to the production method of the invention to be described below.

In case where the interlayer is a thermoplastic resin layer, preferably, the thermoplastic resin for the layer is the same as the thermoplastic resin for use in the thermoplastic resin layer of the film surface and the thermoplastic resin layer for the film back.

In case where the film of the invention is composed of at least three layers, its constitution may be in any embodiment of “positive/positive/positive”, “positive/positive/negative”, “positive/negative/positive”, “negative/positive/negative”, “negative/negative/positive”, or “negative/negative/negative”; but in the invention, preferred is an embodiment of “positive/positive/positive” or “positive/negative/positive”, and most preferred is an embodiment of “positive/negative/positive”.

(Retardation in in-Plane Direction Re, Retardation in Thickness Direction Rth)

The film of the invention satisfies the following formulae (I) and (II):

30nm Re[0°]≦300nm (I),

40nm≦γ≦300nm (II),

γ=|Re[+40°]−Re[−40°]| (II)′,

wherein Re[0°] means a retardation measured in the normal direction of the film plane at a wavelength of 550 nm, Re[+40°] means a retardation measured in the direction tilted by 40° from the normal line of the film plane to the tilt direction, and Re[−40°] means and the retardation measured in the direction tilted by −40° from the normal line of the film plane to the tilt direction.

The tilt structure as referred to herein means that the alignment characteristics are tilted as seen in the thickness direction, and concretely, this means that the retardation value as measured at a tilted angle in the left or right direction relative to the film surface varies. Specifically, of the film having a tilt structure, γ=|Re[+40°]−Re[−40°]| is not 0. In the invention, γ of the film is measured when all the constitutive layers of the film are laminated, but does not means the value of each constitutive layer.

The film of the invention more preferably satisfies the following formulae (II) and (IV):

40nm≦Re[0°]≦200nm (III),

50nm≦γ≦200nm (IV).

The film of the invention further preferably satisfies the following formulae (V) and (VI):

40nm≦Re[0°]≦150nm (V),

50nm≦γ≦150nm (VI).

When γ is large, it means that Re of the film, as measured with light running thereinto obliquely differs between the left side and the right side, and means that the film is given a tilt structure that appears therein when seen in the thickness direction. This structure is effective for preventing the film from curling, preventing the film from having retardation change with time and preventing the film from having a color shift. Within the range of the above-mentioned formula (II), the invention produces great improvement.

Re[0°] is the retardation of the film in the front direction of the film. Within the range defined in the invention, the film is effective for preventing a color shift when used in a liquid crystal compensation film, and is effective for increasing the contrast of display panels.

The fluctuation in Re[0°], Re[+40°] and Re[−40°] causes display unevenness in liquid crystal display devices, and therefore, smaller fluctuation is preferable. Concretely, the fluctuation in Re[0°], Re[+40°] and Re[−40°] is preferably within ±3 nm, more preferably within ±1 nm. Similarly, the fluctuation in the slow axis angle also causes display unevenness, and therefore small fluctuation is preferable. Concretely, the angle fluctuation in the slow axis is preferably within ±1°, more preferably within ±0.5°, even more preferably within ±0.25°.

Preferably, the retardation (Rth) in the thickness direction is from −100 nm to 100 nm, more preferably from −90 nm to 0 nm, even more preferably from −80 nm to −10 nm. Within the range of from −100 nm to 100 nm, the film is effective for color shift prevention, and when incorporated in a liquid crystal display device, the film favorably acts to increase the image contrast and prevents visible unevenness in the horizontal direction.

0029-0031

In the description, Re[0°] (unit: nm) and Rth (unit: nm) each indicate retardation in plane and retardation along thickness direction of an optically-anisotropic layer, a film, a laminate or the like.

Re[0°] is measured by applying a light having a wavelength of 590 nm in the normal direction of the film, using KOBRA-21ADH or WR (by Oji Scientific Instruments). Re at a wavelength of λ nm may be calculated by changing a wavelength selecting filter manually and measuring the retardation value at a wavelength of λ nm, or by measuring retardation value at any wavelength and converting it to the retardation value at a wavelength of λ nm by appropriate program or the like.

When a film to be tested is represented by a uniaxial or biaxial refractive index ellipsoid, then its Rth is calculate according to the method mentioned below.

With the in-plane slow axis (determined by KOBRA 21ADH or WR) taken as the inclination axis (rotation axis) of the film (in case where the film has no slow axis, the rotation axis of the film may be in any in-plane direction of the film), Re of the film is measured at 11 points in all thereof, from −50° to +50° relative to the normal direction of the film at intervals of 10°, by applying a light having a wavelength of 550 nm from the inclined direction of the film.

With the in-plane slow axis from the normal direction taken as the rotation axis thereof, when the film has a zero retardation value at a certain inclination angle, then the symbol of the retardation value of the film at an inclination angle larger than that inclination angle is changed to a negative one, and then applied to KOBRA 21ADH or WR for computation.

With the slow axis taken as the inclination axis (rotation axis) (in case where the film has no slow axis, the rotation axis of the film may be in any in-plane direction of the film), the retardation values of the film are measured in any inclined two directions; and based on the data and the mean refractive index and the inputted film thickness, Rth may be calculated according to the following formulae (1) and (2):

$$\begin{matrix}Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} & ( 1 ) \\ Rth = \{ ( nx + ny ) / 2 - nz \} \times d & ( 2 )\end{matrix}$$

wherein Re(θ) means the retardation value of the film in the direction inclined by an angle θ from the film normal direction; nx means the in-plane refractive index of the film in the slow axis direction; ny means the in-plane refractive index of the film in the direction vertical to nx; nz means the refractive index of the film vertical to nx and ny; and d is a thickness of the film.

When the film to be tested can not be represented by a uniaxial or biaxial index ellipsoid, or that is, when the film does not have an optical axis, then its Rth may be calculated according to the method mentioned below.

With the in-plane arbitrary inputted direction (capable to be input to KOBRA 21ADH or WR) taken as the inclination axis (rotation axis) of the film, Re of the film is measured at 11 points in all thereof, from −50° to +50° relative to the normal direction of the film at intervals of 10°, by applying a light having a wavelength of 550 nm from the inclined direction of the film. Based on the thus-determined retardation data of Re(λ), the mean refractive index and the inputted film thickness, Rth(λ) of the film is calculated with KOBRA 21ADH or WR.

The mean refractive index may be used values described in catalogs for various types of optical films. When the mean refractive index has not known, it may be measured with Abbe refractometer. The mean refractive index for major optical film is described below: cellulose acetate (1.48), cycloolefin polymer (1.52), polycarbonate (1.59), polymethylmethacrylate (1.49) and polystyrene (1.59).

The mean refractive index and the film thickness are inputted in KOBRA 21ADH or WR, nx, ny and nz are calculated therewith. From the thus-calculated data of nx, ny and nz, Nz=(nx−nz)/(nx−ny) is further calculated.

Re(θ), Rth and a refractive index are measured at a wavelength of 550 nm without any remarks in this invention.

In this description, Re[0°], Re[+40°] and Re[−40°] of the film means the retardation value measured in the normal direction of the film (at a tilt angle of 0°), the retardation value measured in the direction tilted by 40° from the normal line to the tilt direction or the temporary tilt direction (at a tilt angle of 40 degrees), and the retardation value measured in the direction tilted by −40° from the normal line to the tilt direction or the temporary tilt direction (at a tile angle of −40 degrees), respectively, at a wavelength of 550 nm.

The tilt direction is determined as follows:

(1) The slow axial direction in the film plane is taken as 0°, and the fast axial direction in the film plane is taken as 90°. A temporary tilt direction is set at intervals of 0.1° between 0° and 90°.

(2) Re[+40°] and Re[−40°] are measured in the directions tilted by +40° and −40° from the normal line of the film to each temporary tilt direction, and |Re[+40°]−Re[−40°]| of each temporary tilt direction is computed.

(3) The direction in which the |Re[+40°]−Re[−40°]| is the largest is taken as the tilt direction.

That is, in the invention, “having a tilt direction” means existing a direction where the |Re[+40°]−Re[−40°]| is the largest.

In this description, Rth of the film is computed with KOBRA 21ADH or WR in the tilt direction taken as the inclination axis (rotation axis) of the film.

### (Temporal Stability of Retardation (Re))

Having the tilt structure, the film of the invention has the advantage of improving the temporal stability of retardation (Re) thereof. Re expresses through alignment of the polymer segments constituting the film, and the alignment disorder results in Re reduction. In ordinary stretching, the segments are aligned along the film surface. Accordingly, the alignment is disordered only when the linking moiety between the segments moves only a little, and Re is thereby varied. On the other hand, in the tilt structure, the segments are aligned in an oblique direction, and for disordering them, the segments must be moved greatly. Given the tilt structure, therefore, the film of the invention can prevent the temporal change in retardation thereof.

### (Thermoplastic Resin)

The thermoplastic resin for use in the invention is not specifically defined, for which, however, preferred is use of both a positive birefringent resin and a negative birefringent resin. Specifically, it is desirable that the film of the invention comprises a layer of a positive birefringent resin and a layer of a negative birefringent resin. Comprising those layers, the film can compensate the thickness-direction refractive index in a range of from a positive level to a negative level and can be a compensation film having a higher accuracy in a broader range.

In particular, when a resin having an inherent positive birefringence (cellulose acylate resin, cyclic olefin resin, polycarbonate resin, etc.) is given shearing deformation between two rolls, then it forms a film with γ>0 in which the slow axis faces the tilt direction; and for example, when the two rolls are arranged in parallel to the die outlet port, the tilt direction is the same as the machine direction of the film.

In case where a resin having an inherent negative birefringence (acrylic resin, styrene resin, etc.) is processed as above, it forms a film with γ>0 in which the fast axis faces the tilt direction.

The film of the invention is preferably produced through co-extrusion of a positive birefringent resin and a negative birefringent resin, as securing optical compensation in a broader range.

(1) Positive Birefringent Resins

Examples of the positive birefringent resins (polymers having a positive value of intrinsic birefringence) include polymers having an alicyclic structure, polyolefin polymers, polycarbonate polymers, polyester polymers such as polyethylene terephthalate, polyvinyl chloride polymers, polysulfone polymers, polyether sulfone polymers, polyarylate polymers, acetate polymers such as triacetylcellulose and liquid crystalline resins. Among these materials, polymers having an alicyclic structure are preferable.

The film of the invention preferably includes cyclo olefin polymers as a positive birefringent resin to form the tilt direction easily by nip-pressing.

### (1-1) Polymers Having an Alicyclic Structure

Examples of the polymer having an alicyclic structure include norbornene-based polymers, polymers based on cyclic olefins having a single ring, cyclic conjugate diene-based polymers, polymers of vinyl alicyclic hydrocarbons and hydrogenation products of these polymers. Among these polymers, norbornene-based polymers are preferable from the standpoint of transparency and the molding property.

Examples of the norbornene-based polymer include ring-opening polymers of monomers having a norbornene structure, ring-opening copolymers of monomers having a norbornene structure with other monomers copolymerizable with the monomers having the norbornene structure in accordance with the ring-opening copolymerization, hydrogenation products of these polymers, addition polymers of monomers having a norbornene structure, addition-type copolymers of monomers having a norbornene structure with other monomers copolymerizable with the monomers having a norbornene structure and hydrogenation products of these polymers. Among these polymers, hydrogenation products of ring-opening (co)polymers of monomers having a norbornene structure are preferable from the standpoint of transparency, the molding property, heat resistance, small moisture absorption, dimensional stability and light weight.

The norbornene-based polymers may be produced according to any polymerization method of ring-opening polymerization or addition polymerization. Addition polymerization and norbornene-based polymers obtained by it are described, for example, in Japanese Patents 3517471, 3559360, 3867178, 3871721, 3907908, 3945598, JP-T 2005-527696, JP-A 2006-28993, 2006-11361, WO2006/004376, WO2006/030797, JP-A 2005-173584, WO2005/050299. Especially preferred are those described in Japanese Patent 3517471 and WO2005/050299.

Ring-opening polymerization and norbornene-based polymers obtained by it are described, for example, in WO98/14499, Japanese Patents 3060532, 3220478, 3273046, 3404027, 3428176, 3687231, 3873934, 3912159. Especially preferred are those described in WO98/14499 and Japanese Patent 3060532.

Of such cyclic olefin resins, more preferred are those to be produced through addition polymerization from the viewpoint of the birefringence expressibility and the melt viscosity thereof; and for example, “TOPAS #6013” (by Polyplastics) can be used.

### (1-2) Cellulose Acylate Resins

Examples of cellulose acylate resins usable in the invention include cellulose acylates where at least a part of three hydroxyl groups in the cellulose unit are substituted with an acyl group. The acyl group (preferably acyl group having from 3 to 22 carbon atoms) may be any of an aliphatic acyl group or an aromatic acyl group. In particular, preferred are cellulose acylates having an aliphatic acyl group, more preferably an aliphatic acyl group having from 3 to 7 carbon atoms, even more preferably an aliphatic acyl group having from 3 to 6 carbon atoms, even more preferably an aliphatic acyl group having from 3 to 5 carbon atoms. One molecule of the resin may have two or more different types of acyl groups. Preferred examples of the acyl group include an acetyl group, a propionyl group, a butyryl group, a pentanoyl group, a hexanoyl group. Of those, more preferred are cellulose acylates having one or more selected from an acetyl group, a propionyl group and a butyryl group; even more preferred are cellulose acylates having both an acetyl group and a propionyl group (CAP). CAP is preferred since its production is easy and since its extrusion stability is good.

The mass-average degree of polymerization and the number-average molecular weight of the cellulose acylate resin are not specifically defined. In general, the mass-average degree of polymerization is from 350 to 800 or so, and the number-average molecular weight if from 70000 to 230000 or so. The cellulose acylate resin may be produced, using an acid anhydride or an acid chloride as an acylating agent. In a most popular production method on an industrial scale, cellulose obtained from a cotton linter or a wood pulp is esterified with a mixed organic acid ingredient including an organic acid (acetic acid, propionic acid, butyric acid) or its acid anhydride (acetic anhydride, propionic anhydride, butyric anhydride) corresponding to an acetyl group or other acyl group, to produce a cellulose ester. For the method for producing a cellulose acylate satisfying the above formulae (S-1) and (S-2), referred to are the description in Hatsumei Kyokai Disclosure Bulletin (No. 2001-1745, issued on Mar. 15, 2001, by Hatsumei Kyokai), pp. 7-12, and the methods described in JP-A 2006-45500, 2006-241433, 2007-138141, 2001-188128, 2006-142800, 2007-98917. The total degree of substitution with acyl group of the hydroxyl group in cellulose is preferably from 2.1 to 3.0. The degree of substitution with acetyl group of the hydroxyl group in cellulose is preferably from 0.05 to 2.5, more preferably from 0.05 to 0.5 or 1.5 to 2.5. The degree of substitution with propionyl group of the hydroxyl group in cellulose is preferably from 0.1 to 2.8, more preferably from 0.1 to 1.2 or 2.3 to 2.8.

### (1-3) Polycarbonate Resins:

As the polycarbonate resin usable in the invention, there is mentioned a polycarbonate resin having a bisphenol A skeleton, which may be produced by reacting a dihydroxy component and a carbonate precursor according to an interfacial polymerization method or a melt polymerization method. For example, preferred for use herein are those described in JP-A 2006-277914, 2006-106386, 2006-284703. For example, a commercial product, “Toughlon MD1500” (by Idemitsu Kosan) can be used here.

If desired, the additives described in the section of the material having an inherent negative birefringence may also be added to the material having an inherent positive birefringence within a range not detracting from the effect of the invention.

The thermoplastic resin layer containing a material having an inherent positive birefringence may contain any other material, but preferably, the layer is formed of a material having an inherent positive birefringence.

(2) Negative Birefringent Resins:

The resin having an inherent negative birefringence (of which the inherent birefringence is a negative value) is such that, when a layer thereof with uniaxially-ordered molecular alignment receives light running thereinto, the refractive index of the light in the alignment direction is smaller than the refractive index of the light in the direction perpendicular to the alignment direction.

The material having an inherent negative birefringence includes a vinyl aromatic polymer, a polyacrylonitrile polymer, a polymethyl methacrylate polymer, and their polynary copolymers. One or more such materials having an inherent negative birefringence may be employable here either singly or as combined. Of those, preferred are a vinyl aromatic polymer, a polyacrylonitrile polymer and a polymethyl methacrylate polymer; and for the film of the invention, preferably used is a negative birefringent resin of vinyl aromatic resin from the viewpoint of high birefringence expressibility thereof.

### (2-1) Vinyl Aromatic Polymers:

The vinyl aromatic polymer includes, for example, polystyrene, and copolymers of a vinyl aromatic monomer such as styrene, α-methylstyrene, o-methylstyrene, p-methylstyrene, p-chlorostyrene, p-nitrostyrene, p-aminostyrene, p-carboxystyrene, p-phenylstyrene or the like, with any other monomer such as ethylene, propylene, butadiene, isoprene, (meth) acrylonitrile, α-chloroacrylonitrile, methyl (meth)acrylate, ethyl(meth)acrylate, (meth)acrylic acid, maleic anhydride, vinyl acetate or the like. Especially preferred are copolymer resins capable of improving the birefringence, the mechanical strength and the heat resistance of the films.

The copolymer resins include, for example, styrene/acrylonitrile resins, styrene/acryl resins, styrene/maleic anhydride resins, and their polynary (e.g., binary, ternary) copolymers. Of those, preferred are styrene/acryl resins and styrene/maleic anhydride resin from the viewpoint of the heat resistance and the mechanical strength of the films.

Preferably, the styrene/maleic anhydride resin has a composition ratio by mass of styrene to maleic anhydride, styrene/maleic anhydride of from 95/5 to 50/50, more preferably from 90/10 to 70/30. For controlling the intrinsic birefringence of the film, the styrene resin may be preferably hydrogenated.

As one example of the styrene/maleic anhydride resins, there is mentioned Nova Chemicals Corporation's “Daylark D332”.

Also usable as the styrene/maleic anhydride is Asahi Kasei Chemicals Corporation's “Delpet 98ON” to be mentioned below.

### (2-2) Acrylic Resins

The acrylic resins usable in the invention include resins to be obtained through polymerization of acrylic acid, methacrylic acid a derivative thereof, and their derivatives. Not specifically defined without detracting from the effect of the invention, all known methacrylic thermoplastic resins are usable in the invention.

Resins to be produced through polymerization of acrylic acid, methacrylic acid and a derivative thereof include, for example, those having a structure of the following general formula (1):

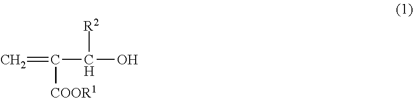

In formula (I), R¹ and R² each independently represent a hydrogen atom or an organic residue having from 1 to 20 carbon atoms. The organic residue is concretely a linear, branched or cyclic alkyl group having from 1 to 20 carbon atoms.

Preferred examples of the monomers to give the resins through polymerization of the compound (monomer) having a structure of the general formula (1), acrylic acid, methacrylic acid or a derivative thereof include methyl(meth)acrylate, ethyl(meth)acrylate, n-propyl(meth)acrylate, n-butyl (meth)acrylate, tert-butyl(meth)acrylate, n-hexyl (meth)acrylate, 2-chloroethyl(meth)acrylate, 2-hydroxyethyl (meth)acrylate, 3-hydroxypropyl(meth)acrylate, 2,3,4,5,6-pentahydroxyhexyl(meth)acrylate and 2,3,4,5-tetrahydroxypentyl(meth)acrylate. More preferred is methyl(meth)acrylate (hereinafter this may be referred to as “MMA”) from the viewpoint of the excellent heat stability of the polymers thereof. One or more of these monomers may be used either singly or as combined. The polymer may be a homopolymer of one of these monomers or a copolymer of two or more of them, or a copolymer with any other resin. From the viewpoint of elevating the glass transition temperature of the film, preferred is a copolymer with any other resin.

Of the above-mentioned acrylic copolymer resins, more preferred are those having an MMA unit (monomer unit) of at least 30% by mol of all the monomers constituting the resin. Also preferably, the resins may contain at least one unit selected from lactone ring units and maleic anhydride units, glutaric anhydride units in addition to MMA; and for example, the resins mentioned below are usable. Of those, further preferred are (i) acrylic resins containing lactone ring unit and (ii) acrylic resins containing maleic anhydride unit.

Preferably, the glass transition temperature (Tg) of these resins is from 106° C. to 170° C., more preferably from 110° C. to 160° C., even more preferably from 115° C. to 150° C.

### (i) Acrylic Resin Containing Lactone Ring Unit:

Usable are those described in JP-A 2007-297615, 2007-63541, 2007-70607, 2007-100044, 2007-254726, 2007-254727, 2007-261265, 2007-293272, 2007-297619, 2007-316366, 2008-9378, 2008-76764. More preferred are resins described in JP-A 2008-9378.

### (ii) Acrylic Resin Containing Maleic Anhydride Unit:

Usable are those described in 2007-113109, 2003-292714, 6-279546, 2007-51233 (acid-modified vinyl resins described therein), 2001-270905, 2002-167694, 2000-302988, 2007-113110, 2007-11565. More preferred are those described in JP-A 2007-113109. Also preferred are commercially-available maleic acid-modified MAS resins (e.g., Asahi Kasei Chemicals' Delpet 980N).

(iii) Acrylic Resin Containing Glutaric Anhydride Unit:

Usable are those described in JP-A 2006-241263, 2004-70290, 2004-70296, 2004-126546, 2004-163924, 2004-291302, 2004-292812, 2005-314534, 2005-326613, 2005-331728, 2006-131898, 2006-134872, 2006-206881, 2006-241197, 2006-283013, 2007-118266, 2007-176982, 2007-178504, 2007-197703, 2008-74918, WO2005/105918. More preferred are the resins described in JP-A 2008-74918.

### (2-3) Acrylonitrile Resins:

For example, those described in JP-A 5-257014, 6-328582, 2004-90415, 2005-126560, 2006-259622 and 2008-276208 are usable here.

In the invention, if desired, the additives described in the section of the material having an inherent positive birefringence may also be added to the material having an inherent negative birefringence within a range not detracting from the effect of the invention.

The thermoplastic resin layer containing a material having an inherent negative birefringence may contain any other material; but preferably, the layer is formed of a material having an inherent negative birefringence.

In case where the thermoplastic resin is a copolymer, it may be a random copolymer or a block copolymer.

### (Additive)

In the invention, if desired, various known additives may be added to the resin having an inherent negative birefringence or to the resin having an inherent positive birefringence within a range not detracting from the advantage of the invention; and the additives include antioxidant, heat stabilizer, light stabilizer, UV absorbent, plasticizer, fine particles, optical regulator, antistatic agent, dispersant, chlorine scavenger, flame retardant, crystal-nucleating agent, antiblocking agent, antifoggant, release agent, pigment, organic or inorganic filler, neutralizing agent, lubricant, disintegrator, metal inactivator, antifouling agent, microbicide, other resin, thermoplastic elastomer, etc.

### Stabilizer:

The film of the invention may contain at least one stabilizer. Preferably, the stabilizer is added before or during hot melting of thermoplastic resin. The stabilizer is effective for antioxidation of film-constituting ingredients, for trapping the acids formed through decomposition, and for retarding or inhibiting the radical group-caused decomposition under light or heat. The stabilizer is effective for inhibiting degradation such as discoloration or molecular weight reduction to be caused by various types of decompositions including decomposition not as yet clarified, and also inhibiting formation of volatile ingredients. The stabilizer is required to be still effective to exhibit its function, without being decomposed at the resin melting temperature at which the resin is formed into a film. Typical example of the stabilizer includes phenol-type stabilizers, phosphite-type stabilizers, thioether-type stabilizers, amine-type stabilizers, epoxy-type stabilizers, lactone-type stabilizers, amine-type stabilizers, metal inactivators (tin-type stabilizers), etc. These are described in JP-A 3-199201, 5-1907073, 5-194789, 5-271471, 6-107854. Preferably, at lest one of phenol-type and phosphite-type stabilizers is used in the invention. Of phenol-type stabilizers, more preferred are those having a molecular weight of at least 500. Preferred phenol-type stabilizers include hindered phenol-type stabilizers.

These materials are readily available as commercial products, and are sold, for example, by the following manufacturers. Ciba Specialty Chemicals provides commercial products of Irganox 1076, Irganox 1010, Irganox 3113, Irganox 245, Irganox 1135, Irganox 1330, Irganox 259, Irganox 565, Irganox 1035, Irganox 1098, Irganox 1425WL. Asahi Denka Kogyo provides commercial products of Adekastab AO-50, Adekastab AO-60, Adekastab AO-20, Adekastab AO-70, Adekastab AO-80. Sumitomo Chemical provides commercial products Sumilizer BP-76, Sumilizer BP-101, Sumilizer GA-80. Shipro Chemical provides commercial products Seenox 326M, Seenox 336B.

As phosphite-type stabilizers, more preferred are the compounds described in JP-A 2004-182979, paragraphs [0023]-[0039]. Specific examples of phosphite-type stabilizers include compounds described in JP-A 51-70316, 10-306175, 57-78431, 54-157159, 55-13765. As other stabilizers, preferred are the materials described in detail in Hatsumei Kyokai Disclosure Bulletin (No. 2001-1745, issued on Mar. 15, 2001, by Hatsumei Kyokai), pp. 17-22.

The phosphite-type stabilizers are preferably high-molecular ones for securing the stability thereof at high temperatures, having a molecular weight of at least 500, more preferably at least 550, even more preferably at least 600. Also preferably, the stabilizers have an aromatic ester group as at least one substituent therein. Also preferably, the phosphite-type stabilizers are triesters, more preferably not mixed with impurities of phosphoric acid, monoester or diester. In case where the stabilizer contains such impurities, preferably, the content of the impurities is at most 5% by mass, more preferably at most 3% by mass, even more preferably at most 2% by mass. For the stabilizers of the type, usable are the compounds described in JP-A 2004-182979, [0023] to [0039], and also usable are the compounds described n JP-A 51-70316, 10-306175, 57-78431, 54-157159, 55-13765. Preferred examples of phosphite-type stabilizers are mentioned below. However, the phosphite-type stabilizers for use in the invention should not be limited to these.

Asahi Denka provides commercial products of Adekastab 1178, 2112, PEP-8, PEP-24G, PEP-36G, HP-10; and Clariant provides commercial products of Sandostab P-EPQ. Also preferred for use herein are stabilizers having both phenol and phosphite moieties in one molecule. The compounds are described in detail in JP-A 10-273494, and their examples are, but not limited thereto, within the scope of the examples of the stabilizers mentioned in the above. Typically, Sumitomo Chemical provides commercial products of Sumilizer GP. Further, Sumitomo Chemical provides other commercial products of Sumilizer TPL, TPM, TPS, TDP. Asahi Denka Kogyo provides commercial products of Adekastab AO-412S.

One or more of the above-mentioned stabilizers may be used herein either singly or as combined. Not detracting from the object of the invention, the amount of the stabilizer to be in the film may be suitably determined. Preferably, the amount of the stabilizer to be added is from 0.001 to 5% by mass relative to the mass of the thermoplastic resin, more preferably from 0.005 to 3% by mass, even more preferably from 0.01 to 0.8% by mass.

### UV Absorbent:

The film of the invention may contain one or more UV absorbents. The UV absorbent is preferably one excellent in the ability of absorbing UV rays having a wavelength of not longer than 380 nm from the viewpoint of antioxidation, and not so much absorbing visible rays having a wavelength of not shorter than 400 nm from the viewpoint of transparency. For example, there are mentioned oxybenzophenone-type compounds, benzotriazole-type compounds, salicylate-type compounds, benzophenone-type compounds, cyanoacrylate-type compounds, and nickel complex-type compounds. Especially preferred UV absorbents are benzotriazole-type compounds and benzophenone-type compounds. Above all, benzotriazole-type compounds are more preferred as causing little unnecessary coloration of cellulose mixed esters. These are described in JP-A 60-235852, 3-199201, 5-1907073, 5-194789, 5-271471, 6-107854, 6-118233, 6-148430, 7-11055, 7-11056, 8-29619, 8-239509, 2000-204173.

The amount of the UV absorbent to be added is preferably from 0.01 to 2% by mass of the thermoplastic resin, more preferably from 0.01 to 1.5% by mass.

### Light Stabilizer:

The film of the invention may contain one or more light stabilizers. The light stabilizer includes hindered amine-type light stabilizers, HALS compounds, more concretely, 2,2,6,6-tetraalkylpiperidine compounds and their acid addition salts and their complexes with metal compounds, as in U.S. Pat. No. 4,619,956, columns 5-11, and U.S. Pat. No. 4,839,405, columns 3-5. Regarding these, Asahi Denka provides commercial products of Adekastab LA-57, LA-52, LA-67, LA-62, LA-77; and Ciba Speciality Chemicals provides commercial products of TINUVIN 765, 144.

One or more of these hindered amine-type light stabilizers may be used either singly or as combined. Needless-to-say, the hindered amine-type light stabilizer may be used, as combined with other additives such as plasticizer, stabilizer, UV absorbent, etc.; and it may be incorporated as a part of the molecular structure in these additives. The amount of the light stabilizer may be determined within a range not detracting from the effect of the invention, and in general, it may be from 0.01 to 20 parts by mass or so relative to 100 parts by mass of the thermoplastic resin, more preferably from 0.02 to 15 parts by mass or so, even more preferably from 0.05 to 10 parts by mass or so. The light stabilizer may be added in any stage of preparing a melt of thermoplastic resin composition, and for example, it may be added in the final step of that.

### Plasticizer:

The film of the invention may contain a plasticizer.

Adding a plasticizer to the film is favorable from the viewpoint of film reformation, for example, for improving the mechanical properties of the film, imparting flexibility to the film, imparting water absorbability to the film or reducing the moisture permeability of the film. In case where the film of the invention is produced according to a melt formation method, a plasticizer may be added to the film for the purpose of depressing the melting temperature of the film-constituting material through plasticizer addition thereto, than the glass transition temperature of the thermoplastic resin used, or for the purpose of reducing the viscosity of the resin composition at the same heating temperature than that of the thermoplastic resin to which the plasticizer is not added. For example, for the film of the invention, preferably used are plasticizers selected from phosphate derivatives and carboxylate derivatives. In addition, also preferably used are polymers produced through polymerization of ethylenic unsaturated monomers and having a weight-average molecular weight of from 500 to 10000, as in JP-A 2003-12859, as well as acrylic polymers, acrylic polymers having an aromatic ring in the side branches, and acrylic polymers having a cyclohexyl group in the side branches.

### Fine Particles:

The film of the invention may contain fine particles. The fine particles include fine particles of inorganic compounds, and fine particles of organic compounds, and any these are usable herein. The mean primary particle size of the fine particles to be in the thermoplastic resin for use in the invention is preferably from 5 nm to 3 μm from the viewpoint of reducing the haze of the film, more preferably from 5 nm to 2.5 μm, even more preferably from 10 nm to 2.0 μm. The mean primary particle size of fine particles as referred to herein is determined as follows: A thermoplastic resin composition is observed with a transmission electronic microscope (having a magnification of from 500,000 to 1,000,000 powers), and the primary particle size of 100 particles is measured, and the data are averaged to be the mean primary particle size of the fine particles. The amount of fine particles to be added is preferably from 0.005 to 1.0% by mass relative to the thermoplastic resin, more preferably from 0.01 to 0.8% by mass, even more preferably from 0.02 to 0.4% by mass.

### Optical Regulator:

The film of the invention may contain an optical regulator. The optical regulator includes a retardation regulator, for which, for example, usable are those described in JP-A 2001-166144, 2003-344655, 2003-248117, 2003-66230. The optical regulator, if added to the film, may control the in-plane retardation (Re) and the thickness-direction retardation (Rth) of the film. Preferably, the amount of the optical regulator to be added is from 0 to 10% by mass, more preferably from 0 to 8% by mass, even more preferably from 0 to 6% by mass.

On the other hand, the film of the invention comprises a thermoplastic resin, and preferably, it does not substantially contain a polymerizing liquid crystal compound generally for use in a film produced through coating, in order that it can express optical compensation capability as it has a single-layer constitution. The polymerizing liquid crystal compound as referred to in the invention is meant to indicate a liquid crystal compound, which is applied to a support, then aligned and polymerized thereon, and thereafter processed for fixation of the alignment state thereof, as in JP-A 2001-328973, 2006-227630, 2006-323069, 2007-248780. In the film of the invention, the content of the polymerizing liquid crystal compound of the type is preferably less than 10% by mass, more preferably less than 5% by mass.

The polymerizing liquid crystal compound includes, for example, those described in JP-A 2001-328973, [0008] to [0034]; JP-A 2006-227630, [0017]; JP-A 2007-248780, [0014] to [0097].

### (Adhesive Layer)

Further, an adhesive layer may be provided between the positive birefringent layer and the negative birefringent layer. The adhesive layer may be formed of a material having an affinity to both the layers constituting the optical laminate. For example, the material includes ethylene/(meth)acrylate copolymers such as ethylene/methyl(meth)acrylate copolymer, ethylene/ethyl(meth)acrylate copolymer; ethylene copolymers such as ethylene/vinyl acetate copolymer, ethylene/styrene copolymer; and other olefinic copolymers, styrene/butadiene copolymers, styrene/isoprene copolymers and their hydrated derivatives. Also usable here are their modified derivatives produced by modifying those (co)polymers through oxidation, saponification, chlorination, chlorosulfonation or the like. In addition, preferred is use of the adhesives described in JP-A 2003-136635, 2004-58369, 2007-245729.

The thickness of the adhesive layer is preferably from 1 to 50 μm, more preferably from 2 to 30 μm.

In counting the number of the thermoplastic resin layers laminated to constitute the film of the invention, the adhesive layer is not taken into consideration. The adhesive layer does not contribute toward optical characteristics of the film and does not contribute toward the curling resistance thereof since its elastic modulus is low. In fact, Tg of the adhesive layer is lower than room temperature in order that the layer exhibits its adhesiveness (stickiness), and as compared with that of the positive or negative birefringent layers, the intensity of the adhesive layer is only 1/100 or less of the other constitutive layers in point of both the stickiness and the elasticity, and therefore the adhesive layer has no mechanical influence on the film. Accordingly, in the film of the invention, the number of the constitutive thermoplastic resin layers does not include the adhesive layer.

(Layer Constitution with Adhesive Layer)

The positive or negative birefringent layer and the adhesive layer may be laminated in any manner, and for example, the following combinations may be mentioned.

a) Positive birefringent layer/negative birefringent layer
b) Positive birefringent layer/adhesive layer/negative birefringent layer
c) Positive birefringent layer/negative birefringent layer/positive birefringent layer
d) Negative birefringent layer/positive birefringent layer/negative birefringent layer
e) Positive birefringent layer/adhesive layer/negative birefringent layer/adhesive layer/positive birefringent layer
f) Negative birefringent layer/adhesive layer/positive birefringent layer/adhesive layer/negative birefringent layer

Of those, preferred are c) and e). The ratio of the total thickness of positive birefringent layer/total thickness of negative birefringent layer is preferably from 0.1 to 5, more preferably from 0.2 to 3. The thickness of the adhesive layer is preferably from 1% to 30% of the thickness of all the layers, more preferably from 2% to 20%, even more preferably from 3% to 15%.

### (Film Surface Condition)

Preferably, the outer surface of the formed film is flat.

Preferably, the die lines are grooved lines having a depth of less than 50 nm or a width of more than 500 nm, or projected lines having a height of less than 50 nm or a width of more than 500 nm. More preferably, the die liens are grooved lines having a depth of less than 30 nm or a width of more than 700 nm, or projected lines having a height of less than 30 nm or a width of more than 700 nm. Having the constitution, the film can prevent light interference or light leakage based on the light refraction on the linear grooves or the linear projections.

### (Tenter Stretching)

Preferably, the thermoplastic film of the invention having the tilt structure in the thickness direction, which is unstretched or is stretched in the machine direction (MD) of the film, in the transverse direction (TD) of the film or in the oblique direction thereof, using a tenter. The thus-stretched film of the invention is favorable as its curling resistance is further enhanced. In the film of the invention, the tilt structure is in the machine direction of the film, and the elastic modulus of the film in that direction is higher; however, by stretching it in TD or in the oblique direction of the film, the slow axis of the film may be aligned in TD while the tilt structure therein is kept in MD. Accordingly, in the thus-stretched film, the elastic modulus in both the tilt axis and the slow axis is increased, and the two can cancel each other therefore further enhancing the curling resistance of the film. In this, the slow axis is made to run in the oblique direction, and therefore, the film stuck to a polarizing film may be prevented from curling. This is because the tilt structure film and the polarizing film are stuck together in the perpendicular direction or in the parallel direction, and therefore, the curling of the film may be reduced by stretching the film in the oblique direction. Preferably, the mean alignment angle of the in-plane slow axis of the film is 45±10° in the MD direction, more preferably 45±5°, even more preferably 45±2°.

The draw ratio in stretching is preferably from 1.05 times to 3 times, more preferably from 1.1 times to 2.6 times, even more preferably from 1.2 times to 2.3 times. When the draw ratio is less than the range, the film could not exhibit the above-mentioned effect, and could hardly exhibit the curling-preventing effect. On the other hand, when the draw ratio is more than the range, then the molecules may be too much aligned in TD, and this is unfavorable since the film could hardly exhibit the cancel effect to the tilt angle, and therefore could hardly exhibit the curling-preventing effect.

### [Method for Production of Thermoplastic Film]

The thermoplastic film of the invention can be produced according to the method described below (hereinafter this may be referred to as the production method of the invention).

The production method of the invention comprises continuously nip-pressing (co-extruding) at least two, thermoplastic resin-containing composition melt layers by leading them to run between a first nip-pressing surface and a second nip-pressing surface of a nip-pressing apparatus with applying a pressure of from 30 MPa to 500 MPa to the melt layers. Differing from conventional methods, the production method is characterized in that such a high pressure is applied to at least two thermoplastic resin-containing melt layers to produce a laminate film.

The nip-pressing unit of which the first nip-pressing surface and the second nip-pressing surface differ in the moving speed thereof includes a combination of two rolls individually running at a different peripheral speed, a combination of a roll and a touch belt individually running at a different speed as in JP-A 2000-219752 (one-side belt system), and a combination of a belt and a belt (double-side belt system). Of those, preferred is a combination of two rolls individually running at a different peripheral speed, as capable of imparting uniform high pressure of from 20 to 500 MPa to the resin melt. The roll pressure may be measured by leading a pressure test film (e.g., FUJIFILM Corporation's middle-pressure prescale) to pass between two rolls.

Co-extrusion further actualizes the temporal stability of Re of the film of the invention. This is because of the following reasons. Re change (relaxation) is caused by reduction in the segment alignment and by the disordered alignment of the segments. This is expressed by the residual strain during film formation (in other words, this is expressed by the strain accompanied by the elongation deformation between the melt and the air gap and by the nip-pressing deformation on the roll). Co-extrusion of different types of thermoplastic resins brings about interfacial mixing of the thermoplastic resin layers whereby the residual stress is absorbed and the Re change is reduced.

The method for producing the film of the invention (hereinafter this may be referred to as “the production method of the invention”) is described in detail hereinunder.

### <Feeding of Melt of Thermoplastic Resin Composition>

In the production method of the invention, first, a thermoplastic resin-containing compound (hereinafter this may be referred to as “thermoplastic resin composition”) is melt-extruded. The method includes a step of leading a melt of the thermoplastic resin composition to pass between a first nip-pressing surface and a second nip-pressing surface of a nip-pressing unit, and thereby continuously nip-pressing it therebetween to form a film (hereinafter this may be referred to as “nip-pressing step”). In the nip-pressing step, the means of feeding the melt of a thermoplastic resin-containing composition to the unit is not specifically defined. For example, as a concrete means for feeding the melt, employable is an embodiment of using an extruder through which a thermoplastic resin composition is melted and extruded as a film; or an embodiment of using an extruder and a die; or an embodiment of once solidifying a thermoplastic resin into a film, then melting it with a heating means into a melt, and thereafter feeding it to a film formation step.

The film production method of the invention preferably includes the step of melt-extruding a thermoplastic resin-containing composition through a die and the step of leading the thus-extruded melt to pass between a first nip-pressing surface and a second nip-pressing surface of a nip-pressing unit, from the viewpoint of more effectively retarding the fluctuation of the optical properties of the films to be produced.

In the case where the thermoplastic resin composition is melt-extruded, preferably, the thermoplastic resin composition is pelletized before it is melt-extruded. Some commercial products of thermoplastic resin (e.g., TOPAS #6013, Toughlon MD1500, Delpet 980N, Daylark D332) are in the form of pellets; however, others not in the form of pellets may be processed according to the method mentioned below. As the thermoplastic resin for use in the method, employable are the thermoplastic resins that may be in the film of the invention, and their preferred ranges may apply to the production method.

The thermoplastic resin composition is dried, then melted in a double-screw kneading extruder at 150° C. to 300° C., then extruded like noodles, and solidified and cut in air or in water, and thereby giving pellets. After melted in the extruder, the melt may be directly cut while extruded into water through a nozzle to give pellets, according to an underwater cutting method. The extruder usable for pelletization includes a single-screw extruder, a non-engaging counter-rotating double-screw extruder, an engaging counter-rotating double-screw extruder, an engaging uni-rotating double-screw extruder, etc. Preferably, the number of revolutions of the extruder is from 10 rpm to 1000 rpm, more preferably from 20 rpm to 700 rpm. The extruder retention time is preferably from 10 seconds to 10 minutes, more preferably from 20 seconds to 5 minutes.

Not specifically defined, the size of the pellets may be generally from 10 mm³ to 1000 mm³ or so, preferably from 30 mm³ to 500 mm³ or so.

Preferably, prior to feeding the melt of thermoplastic resin composition, the water content of the pellets is reduced. Preferably, the drying temperature is from 40 to 200° C., more preferably from 60 to 150° C. Accordingly, the water content is preferably reduced to at most 1.0% by mass, more preferably at most 0.1% by mass.

Further, it is important to reduce the content of the residual solvent in the pellets. For this, there are mentioned (1) a means of reducing the residual solvent itself in the thermoplastic resin; and (2) a means of predrying the thermoplastic resin before use thereof for film formation. The predrying may be attained, for example, by shaping the starting material into pellets and drying them with a hot air dryer. The drying temperature is preferably not lower than 100° C., and the drying time is preferably not shorter than 2 hours. The predrying may reduce the residual solvent in the protective layer, and may prevent the extruded thermoplastic resin from foaming. Accordingly, the residual solvent amount in the film of the invention may be controlled to fall within a preferred range. The drying may be attained in air, or in nitrogen, or in vacuum.

In case where the resin composition is melt-extruded through an extruder, the dried pellets are fed into the cylinder via the feeding port of the extruder, and kneaded and melted therein. Preferably, the inside of the cylinder comprises, for example, a feeing zone, a pressing zone, and a metering zone in that order from the side of the feeing port.

Preferably, using a single-screw or double-screw extruder, the resin for each layer is kneaded at a temperature higher by from 50 to 180° C. than the glass transition temperature (Tg) of the resin. The extruder may be kept at a constant temperature inside it, or the inlet port side of the extruder may be kept at a higher temperature or the outlet port side thereof may be kept at a higher temperature; but more preferably, the resin inlet port is kept at from Tg to (Tg+100)° C., and the extruder outlet port is at from (Tg+50) to (Tg+170)° C.

For increasing the thickness accuracy, preferably used is a double-screw extruder, or a double-flight single-screw extruder. The compression ratio in the extruder is preferably from 2 to 5, more preferably from 2.5 to 4. The ratio of the length (L) to the diameter (D) of the screw, L/D is preferably from 5 to 50, more preferably from 7 to 30.

Preferably, the thermoplastic resin composition melt-extruded through an extruder preferably pass through a breaker plate-type filter, a gear pump and the melting filtration system for removing impurities from the thermoplastic resin composition by filtration therethrough. The filtration may be one-stage or multi-stage filtration. Preferably, the filtration accuracy is from 3 μm to 20 μm, more preferably from 4 μm to 15 μm, further preferably from 5 μm to 10 μm. Stainless steel is preferred for the filter material. The filter constitution includes knitted wire nets, and sintered metal fiber or metal powder articles (sintered filters); and preferred are sintered filters.

For increasing the thickness accuracy by reducing the melt discharge fluctuation, preferably, a gear pump is disposed between the extruder and the thermoplastic resin composition feeding means (e.g., die). Accordingly, the resin pressure fluctuation inside the thermoplastic resin composition feeding means (e.g., die) may be reduced to ±1%. For enhancing the constant feeding capability of the gear pump, there may be employed a method of changing the number of screw revolutions to thereby constantly control the pressure before the gear pump.

For reducing the thickness fluctuation of the film, the number of screw revolutions is preferably 5 rpm or more.

### <Extrusion Step>

The production method of the invention for producing the film of the invention includes a co-extrusion step. For co-extrusion, preferably employed is a co-extrusion T-die method, a co-extrusion inflation method or a co-extrusion lamination method from the viewpoint of the production efficiency and from the viewpoint of not leaving a volatile ingredient such as solvent in the formed film. For co-extrusion shaping, more preferred is a co-extrusion T-die method from the viewpoint of further increasing the thickness accuracy. Specifically, it is desirable that the production method of the invention further includes a step of melt-extruding a thermoplastic resin-containing composition through a die, and in this, the extruded, thermoplastic resin melt is preferably led to pass through the first nip-pressing surface and the second nip-pressing surface of a nip-pressing apparatus.

In the production method of the invention, preferably, at least a positive birefringent resin melt and a negative birefringent resin melt are co-extruded.

The surface layer not having linear grooves or linear projections can be formed as follows: For example, in a T-die extrusion shaping method, the surface roughness of the lips of the T-die is reduced; the lip tip is plated with chromium, nickel, titanium or the like; the lip tip is coated with a ceramic by spraying; the inner face of the lip is coated with a coating film of TiN, TiAlN, TiC, CrN, DLC (diamond-like carbon) or the like according to a PVD (physical vapor deposition) method; the temperature distribution and the air stream around the resin melt just extruded out through a die is uniformly controlled; or the thermoplastic resins to form the individual resin layers are specifically so selected that their melt flow rate value is on the same level.

The other means employable herein for controlling the linear grooves or the linear projections of die lines so as to fall within the above range are as follows: In a T-die extrusion shaping method, the contaminants adhering to the die lip (e.g., burnt residue, dust) are removed; the mold releasability in the die lip part is enhanced; the wettability of the die lip is made uniform on the entire surface thereof; the resin powder is reduced; the dissolved oxygen amount in the resin pellets is reduced; a polymer filter is disposed inside the melt extruder.

The co-extrusion T-die method includes a feed block system and a multi-manifold system; and preferred is a multi-manifold system since the thickness fluctuation in the interlayer 1 can be reduced.

In case where a co-extrusion T-die method is employed, the temperature of the thermoplastic resin melt is preferably higher by from 50 to 180° C. than the glass transition temperature of the thermoplastic resin, more preferably higher by from 80 to 150° C. than the glass transition temperature. When the melt temperature in the extruder is too low, then the flowability of the thermoplastic resin may be poor; but when it is too high, the resin may worsen.

In the extruder having the constitution as above, the resin composition is melted, and if desired, the resin melt is led to pass through a filter and a gear pump, and thereafter it is continuously transferred to the thermoplastic resin composition feeding means (e.g., die). The die may be in any type of a T-die, a fishtail die, or a hanger coat die. Preferably, just before the thermoplastic resin composition feeding means (e.g., die), a static mixer may be disposed for enhancing the uniformity of the resin temperature.

The extrusion temperature (hereinafter this may be referred to as a melt temperature) at the feeding unit (for example, die) through which the above-mentioned thermoplastic resin composition is fed into the extruder may be determined depending on the melt temperature of the thermoplastic resin, but in general, it is preferably from 190 to 300° C. or so. For preventing the resin melt from being oxidized and degraded by existing oxygen, it is desirable that the inside of the extruder is made to have an inert (e.g., nitrogen) current atmosphere or a vented extruder is used and evacuated during the process.

In case where the feeding means is a die, the clearance at the die outlet port part (hereinafter this may be referred to as “lip gap”) is generally from 1.0 to 30 times the film thickness, more preferably from 5.0 to 20 times. Concretely, it is preferably from 0.04 to 3 mm, more preferably from 0.2 to 2 mm, even more preferably from 0.4 to 1.5 mm.

In the production method of the invention, the radius of curvature at the tip of the die lip is not specifically defined, and any known die may be used in the invention.

Preferably, the die thickness is controllable within a range of from 5 to 50 mm. An automatic thickness-controlling die is also effective, for which the film thickness and the thickness deviation in the downstream area are computed, and the data are fed back to the die for thickness control thereof.

Apart from the single-layer film forming apparatus, a multilayer film forming apparatus is also usable herein.

The residence time taken by the thermoplastic resin composition to run into the extruder via the feeding port and then go out of it via the feeding means (e.g., die) is preferably from 3 minutes to 40 minutes, more preferably from 4 minutes to 30 minutes.

### (Interlayer Viscosity Difference Between Thermoplastic Resin Melts)

In the production method of the invention, preferably, the above-mentioned, at least two thermoplastic resin melt layers are given a melt viscosity difference of from 10 Pa·s to 500 Pa·s therebetween. More preferably, the viscosity difference between the thermoplastic resin melts at the outlet port of the co-extrusion T-die is from 10 Pa·s to 500 Pa·s, even more preferably from 15 Pa·s to 400 Pa·s, still more preferably from 20 Pa·s to 300 Pa·s. In general, the melts to be co-extruded into layers are made to have the same melt viscosity; however, in the production method of the invention, the melts are given a viscosity difference as above. Accordingly, there occurs a flowability difference between the melt layers, whereby the layers are partly mixed at the interface therebetween and the residual strain is thereby absorbed and accordingly the temporal change of Re is reduced as above. As opposed to this, when the constitutive melt layers are made to have the same viscosity like in conventional methods, then the resin flows are completely individual flows and could not bring about the mixing effect. The interfacial mixing could be more remarkable when combined with a mode of high-pressure touch roll film formation (to be described below). Specifically, when a touch roll is given a high pressure applied thereto, the melt flow channel may be narrow and the melt flow may be thereby disordered to promote the interlayer mixing of the melts. The mixing effect has an additional effect of further increasing the interlayer adhesiveness.

The interlayer viscosity difference between the thermoplastic resin melts is the melt viscosity difference between the two layers adjacent to each other; and in case where three or more layers are co-extruded, any one melt viscosity difference between the adjacent thermoplastic resin layer melts of all the layer melts may fall within the range of the invention. The melt viscosity difference may be given to any combination with a positive birefringent layer or a negative birefringent layer, since it is for imparting interfacial mixing between the adjacent layer melts. For controlling the melt viscosity difference, for example, the resins for the individual layers may be changed, or the extrusion temperature of the resins may be varied. Specifically, by changing the type of the thermoplastic resins to be used (for example, by lowering the molecular weight thereof), or by elevating the temperature of the resin melts, the melt viscosity of the resin melts may be lowered.

The resins to constitute the individual layers are led to the die from the extruder via the duct therebetween, and therefore, the kneading temperature in the extruder may be elevated, or the duct temperature may be elevated. In case where the duct temperature is elevated, a static mixer may be arranged inside the duct and the melt inside the duct may be stirred with it to thereby enhance the heat transmission efficiency, and the temperature control in the system may be attained accurately.

### (Interlayer Temperature Difference Between Thermoplastic Resin Melts)

In the production method of the invention, preferably, the above-mentioned, at least two thermoplastic resin melt layers are given a temperature difference of from 1° C. to 30° C. therebetween, more preferably from 2° C. to 27° C., even more preferably from 4° C. to 25° C. The temperature difference between the thermoplastic resin melts brings about interlayer convection flows between the layers and promotes the above-mentioned mixing of the adjacent melts.

The interlayer temperature difference is the temperature difference between the adjacent layers; and in case where three or more layers are formed through co-extrusion, any one melt temperature difference between the adjacent layer melts of all the layer melts may fall within the range of the invention. The melt temperature difference may be given to any combination with a positive birefringent layer or a negative birefringent layer, since it is for imparting interfacial mixing between the adjacent layer melts.

For controlling the interlayer temperature difference between the melts, the resin extrusion temperature may be varied, or the temperature around the die lip may be so controlled that the temperature of the outer layer could be elevated or lowered. A die lip heater, or that is, a short heater having a length of from a few mm to a few cm (in the machine direction) may be arranged around the die outlet port. The time for which the melt may be kept near to the heater of the type is short and therefore the inside of the melt is not so much heated and only the surface part thereof could be heated. Therefore, the heater of the type is favorably used for giving the temperature difference as in the invention. A heater may be arranged in the area (air gap) between the die outlet port and the nip-pressing surface of the nip-pressing apparatus to attain the intended temperature difference. Preferably, the heater to be used for that purpose can emit IR rays having a long wavelength so that it can heat only the surface part of the resin melt. More preferred is a middle IR to far IR heater. (For example, usable are IR heaters or far-IR heaters by Heraeus, NGK or Sakaguchi Electric.) Using these, only the surface part of the resin melt may be heated, whereby a temperature difference can be given to the heated melt. In addition, a temperature-controlled air flow may be given to the air gap to thereby lower the temperature of the outermost layer of the melt. These methods may be employed here either singly or as combined, and a temperature difference may be thereby given to the thickness direction of the melt.

### <Nip-Pressing Step>

Next, the fed melt of thermoplastic resin composition is led to pass between the first nip-pressing surface and the second nip-pressing surface of a nip-pressing unit and is thereby continuously nip-pressed therebetween to form a film, which is then cooled and solidified. In this stage, preferably, the melt is released earlier from any one of the first nip-pressing surface and the second nip-pressing surface and thereafter from the other one, from the viewpoint of the production stability. In the production method of the invention, the moving speed of the first nip-pressing surface is higher than the moving speed of the second nip-pressing surface, and the surface from which the melt is released earlier than from the other may be either the first nip-pressing surface or the second nip-pressing surface; however, from the viewpoint of inhibiting formation of peel lumps, the surface from which the melt is released earlier is preferably the first nip-pressing surface (running at a higher moving speed).

In the production method of the invention, the fed melt of thermoplastic resin composition is continuously nip-pressed between the first nip-pressing surface and the second nip-pressing surface of the nip-pressing unit, to form a film according to a conventional process, in which a pressure of from 20 to 500 MPa is applied to the film-like melt between the nip-pressing surfaces to produce the film having the specific optical properties of the invention. Preferably, the pressure is from 25 to 300 MPa, more preferably from 25 to 200 MPa, even more preferably from 30 to 150 MPa.

When the pressure between the nip-pressing member in the nip-pressing apparatus is at least 30 MPa, a thermoplastic film can be produced, which has at least two thermoplastic resin layers laminated on each other, and in which the thermoplastic resin layer of the film surface and the thermoplastic resin layer of the film back each have a tilt structure in the thickness direction of the film, and in the plane including the tilt direction of the tilt structure and the film normal line, the sign of the angle, φ between the normal direction of the film surface and the tilt direction differs between the thermoplastic resin layer of the film surface and the thermoplastic resin layer of the film back. This is because, when the pressure to be given to the nip-pressing members is controlled to be at least 30 MPa, then the melt flow between the members can be disordered to give a turbulent flow. The segment elongation owing to the flow disturbance is solidified to give segment alignment, and therefore, under the turbulent flow, the film may be given the alignment angle difference in the tilt structure between the back and the surface of the film as in the invention. Further, when the pressure to be given to the nip-pressing members is controlled to be at least 30 MPa, then the interlayer mixing of the co-extruded layer melts is further promoted and the residual strain may be thereby removed, therefore bringing about an additional effect of enhancing the temporal stability of Re of the formed film. On the other hand, when the pressure is at most 500 MPa, the turbulent flow is not so much strong and the segment alignment in the melt is hardly homogenized, whereby the alignment angle difference can be secured in the tilt structure between the surface and the back of the film.

In the production method of the invention, preferably, the moving speed difference between the first nip-pressing surface and the second nip-pressing surface of the nip-pressing apparatus, as defined according to the following formula, is so controlled as to be from 0.5% to 20%, whereby the thermoplastic resin composition melt fed in the nip-pressing apparatus can be given a shear stress while passing through the nip-pressing members. More preferably, the moving speed difference between the nip-pressing members of the nip-pressing apparatus is from 1% to 15%, even more preferably from 2% to 10%.

Moving Speed Difference(%)=100×{(moving speed of the first nip-pressing surface)−(moving speed of the second nip-pressing surface)}/(moving speed of the first nip-pressing surface).

When the moving speed difference between the two nip-pressing surfaces falls within the range, then the film can readily secure the preferred range of Re[0°], γ and Rth. Further, the moving speed difference may have another effect of promoting the interlayer mixing of the co-extruded thermoplastic resin melts. In case where the moving speed difference is at most 20%, the thermoplastic resin melts hardly slip between their layers, and therefore interlayer mixing of the melts may be easy.

In the production method of the invention, the first nip-pressing surface and the second nip-pressing surface are rigid.

In this description, when the nip-pressing surface is “elastic”, then it must not be judged only by the material of the nip-pressing surface. The surface condition should be determined in consideration of the ratio of the thickness of the rigid material used in the nip-pressing surface part and the thickness of the structure to support the nip-pressing surface. For example, in case where the nip-pressing surface is driven by a spherical support roll, the ratio of (thickness of the outer sheath of rigid material)/(diameter of support roll) is less than 1/80; and for example, this includes a case where a rigid material is used as a part of the touch roll. In other words, a touch roll having, as formed therein, a layer not containing a rigid material at all, such as an elastic layer could be elastically deformed as a whole even though it has, as formed on its surface or inside it, a right material layer, and therefore, the roll of the type is within a category of elastic roll. A roll of which the core is formed of rubber and the surface is formed of a rigid material (that is, a roll having a surface metal ring as the outer sheath thereof) also does not deform at the metal surface thereof; however, since the rotation axis and the center of the surface metal ring may be shifted from each other, the roll of the type is within a category of elastic roll. In addition, the same shall apply also to a roll in which the nip-pressing surface is supported and driven by any other mechanism, like the roll in which the nip-pressing surface is driven by a spherical supporting roll.

### (Melt Temperature)

In the production method of the invention, the melt temperature (temperature of the melt of thermoplastic resin composition at the outlet port of feeding means) is preferably from (Tg+50) to (Tg+200)° C. from the viewpoint of improving the shapability of the melt of thermoplastic resin composition and of preventing the deterioration thereof, more preferably from (Tg+70) to (Tg+180)° C., even more preferably from (Tg+90) to (Tg+150)° C. Specifically, when the melt temperature is not lower than (Tg+50)° C., then the shapability of the melt of thermoplastic resin composition is good since the viscosity of the melt can be sufficiently low; and when the temperature is not higher than (Tg+200)° C., then the melt of thermoplastic resin composition may hardly deteriorate.

### (Air Gap)

In case where a thermoplastic resin composition is fed to a nip-pressing unit through a feeding means such as a die according to the production method of the invention, the air gap (the distance from the outlet port of the feeding means to the melt landing point) is preferably as small as possible from the viewpoint of keeping the temperature of the melt staying in the air gap, and concretely, the air gap is preferably from 10 to 300 mm, more preferably from 20 to 250 mm, even more preferably from 30 to 200 mm.

### (Line Speed)

In the production method of the invention, the line speed (film formation speed) and the stretching speed in the subsequent stretching step to be mentioned below is preferably from 10 m/min to 100 m/min, from the viewpoint of keeping the temperature of the melt in the air gap, more preferably from 15 m/min to 80 m/min, even more preferably from 20 m/min to 60 m/min. When the line speed is not lower than the lowermost limit of the range, then the melt speed between the nip-pressing surfaces (e.g., touch rolls, chill rolls) could be kept high and a turbulent flow effect could be fully given to the running melts. On the other hand, when the line speed is lower than the uppermost limit of the range, then the residence time between the nip-pressing surfaces may not be too short, and the resin melts running therebetween can fully secure the turbulent flow effect. When the line speed is high, then the melt can be prevented from being cooled in the air gap and therefore more uniform shear deformation can be given to the melt while still hot in the nip-pressing unit. The line speed indicates the speed at which the melt of thermoplastic resin composition passes through the nip-pressing unit and the film traveling speed in the conveyance unit.

Preferably, in the production method of the invention, the temperature of the first nip-pressing surface and the second nip-pressing surface is set to fall between (Tg−70° C.) and (Tg+10° C.) where Tg indicates the glass transition temperature of the resin melt to be nip-pressed, more preferably between (Tg−50° C.) and (Tg+5° C.), more preferably between (Tg−40° C.) and Tg. Also preferably, the temperature is lower by from 20° C. to 200° C. than the temperature of the resin melt to be nip-pressed, more preferably by from 20° C. to 150° C., even more preferably by from 20° C. to 100° C. The temperature control may be attained by introducing a temperature-controlled liquid or vapor into the inside of nip-pressing surfaces. Further, for controlling the difference between Re[+40°] and Re[−40°], there may be made a difference between the surface temperature of the first nip-pressing surface and that of the second nip-pressing surface.

In the production method of the invention, the width of the film-like melt is not specifically defined, and may be, for example, from 200 to 2000 mm.

### (Casting Through Two Rolls)

As the method of leading a thermoplastic resin melt to pass between the first nip-pressing surface and the second nip-pressing surface of a nip-pressing unit and nip-pressing it therebetween to form a film, preferred is an embodiment of leading the resin melt to pass between two rolls (e.g., touch roll (first roll) and chill roll (second roll)). In case where the nip-pressing unit includes two rolls individually running at a different peripheral speed, the surface of the roll running at a higher peripheral speed is the first nip-pressing surface, and the surface of the running at a lower peripheral speed is the second nip-pressing surface. In this description, when the filming system includes plural casting rolls for conveying the resin melt, the casting roll nearest to the most upstream thermoplastic resin composition feeding means (e.g., die) may be the chill roll. That is, in the film production method of the invention, preferred is to use the melt casting method in which the extruded melt (resin melt) from extruder is nipped by the chill roll and touch roll. The preferred embodiment of the production method of the invention where two rolls are used is described below.

In the film production method of the invention, the landing point at which the melt extruded out from the above-mentioned feeding means lands is not specifically defined. The distance between the melt landing point and the perpendicular line that runs through the center point in the space at a part at which the touch roll and the casting roll are kept nearest to each other may be zero, or the two may be deviated.

The melt landing point is meant to indicate the point at which the melt extruded out from the feeding means is first brought into contact with the touch roll or the chill roll (or first lands on the roll). The center point of the space between the touch roll and the casting roll is meant to indicate the center point of the touch roll surface and the casting roll surface at the site at which the space between the touch roll and the casting roll is the narrowest.

Preferably, the surface of the two rolls (e.g., touch roll, casting roll) has an arithmetic mean height Ra of at most 100 nm, more preferably at most 50 nm, even more preferably at most 25 nm.

In the production method of the invention, the width of the two rolls is not specifically defined. The width may be freely varied in accordance with the width of the film-like melt.

In the production method of the invention, the cylinder parameter values may be suitably changed for controlling the roll pressure to fall within the above-mentioned range. The cylinder parameter values may differ depending on the resin material to be used and the materials of the two rolls. For example, when the effective width of the film-like melt is 200 mm, the value is preferably from 3 to 100 KN, more preferably from 3 to 50 KN, even more preferably from 3 to 25 KN.

In the production method of the invention, preferably, the Shore hardness of the rolls is at least 30 HS for controlling the roll pressure to fall within the above range, more preferably at least 45 HS. In the invention, the film is continuously formed while the roll pressure is kept high, and therefore, when impurities in the film or dust and others in air are led between the rolls, then the rolls may be dented or may be scratched. Accordingly, the Shore hardness of the two rolls is preferably at least 50 HS, more preferably at least from 60 to 90 HS.

The Shore hardness is determined according to a method of JIS Z 2246 where a roll is tested at 5 points in the roll width direction and at 5 points in the roll peripheral direction and the data are averaged.

The thickness of the touch roll is preferably from 6 mm to 45 mm, more preferably from 10 mm to 40 mm. Even more preferably, the touch roll is a metal roll having a thickness of from 15 mm to 35 mm. The roll of the type secures a high touch pressure (30 MPa to 500 MPa) and facilitates film formation. When the thickness is at least 6 mm, then the roll rigidity may be sufficient, and the touch roll hardly deforms along the chill roll attached thereto, and the contact area between the two rolls hardly increases. When the contact area increases, the intended tilt structure could hardly be formed, there hardly occurs the difference in the tilt angle between the surface and the back of the film (positive/negative), and the interlayer mixing effect could be hardly expressed. In other words, when the thickness is at least 6 mm, then the contact length of the touch roll and the chill roll could hardly be prolonged, and therefore a rapid melt flow channel change may be given to the melt running between the rolls and the melt may be thereby given a turbulent flow (in the method described in JP-A 2002-365428 and 2007-38646, the touch roll used is soft and readily deforms and its contact length is long, and therefore, the method using the touch roll of the type is unfavorable). On the other hand, when the roll thickness is less than 45 mm, then it is favorable since the contact length is not too short and the melt is given a sufficient turbulent flow effect.

Regarding their material, preferably, the two rolls are made of metal from the viewpoint of attaining the above-mentioned Shore hardness, more preferably they are made of stainless metal. Also preferred are surface-plated rolls. The Shore hardness of the rolls may be attained according to a method of quenching/tempering, for example, as in Metal Data Book (edited by the Japan Institute of Metals), Chap. 3. Preferably, the two rolls are made of metal, as their surface roughness is low and therefore the surface of the produced film is hardly scratched. On the other hand, rubber rolls and rubber-lined metal rolls are also usable with no limitation so far as they can attain the above-mentioned high pressure between two rolls.

As the touch roll, for example, usable are those described in JP-A 11-314263, 2002-36332, 11-235747, WO97/28950, JP-A 2004-216717, 2003-145609.

In the production method of the invention, preferably, the peripheral speed ratio of the two rolls between which a film-like melt is led to pass is controlled, whereby a shear stress is given to the resin melt while it passes through the two rolls to give the film of the invention.

In producing the film of the invention, any of the two rolls may run at a higher speed. When the running speed of the touch roll is low, a bank (an excessive melt staying on the roll to form a deposit thereon) is formed on the side of the touch roll. As the touch roll has a shorter period of time than that of the chill roll for which it is kept in contact with the melt, the bank formed on the side of the touch roll could not be fully cooled, therefore giving peel lumps and thereby causing surface failures. Accordingly, it is desirable that the roll running slower is the chill roll (second roll) and the roll running faster is the touch roll (first roll).

In the production method of the invention, the two rolls are preferably those having a large diameter. Concretely, the two rolls have a diameter of from 200 to 1500 mm, more preferably from 300 mm to 1000 mm, even more preferably from 350 mm to 800 mm, still more preferably from 350 mm to 600 mm, further more preferably from 350 to 500 mm. When rolls having such a large diameter are used, then the contact area between the film-like melt and the rolls may be large and the time for which a shear stress is given to the film-like melt is prolonged with the result that films having a large difference between Re[+40°] and Re[−40°] can be produced while reducing the fluctuation in Re[0°], Re[+40°] and Re[−40°] thereof. Also desirably, the deformation of the rolls can be reduced. In the production method of the invention, the two rolls may have the same or different diameter.

In the production method of the invention, the two rolls may be driven at an equal peripheral speed or each at a different peripheral speed. The two rolls may be driven dependently or independently, but preferably, they are driven independently for retarding the fluctuation in Re[0°], Re[+40°] and Re[−40°] of the films to be produced.

In the production method of the invention, preferably, the melt of thermoplastic resin composition fed from the feeding means is kept warmed just before it is brought into contact with at least any one of the two rolls to thereby reduce the temperature fluctuation in the width direction; concretely, the temperature fluctuation of the melt in the width direction is within 5° C. For reducing the temperature fluctuation, preferably, a shielding layer having a heat-insulating function or a heat-reflecting function is disposed in at least a part of the air gap to thereby shield the melt from fresh air. When such a heat-insulting layer is disposed in the pathway in the manner as above to thereby shield the melt from fresh air, then the melt is protected from being exposed to the external environments such as air, and therefore the temperature fluctuation in the film-like melt in the width direction thereof can be reduced. The temperature fluctuation in the film-like melt in the width direction is preferably within ±3° C., more preferably within ±1° C.

Further, when the shielding layer is used, then the film-like melt may be led to pass between the rolls while its temperature is high, or that is, while its melt viscosity is low, and the layer is therefore effective for facilitating the film production in the invention.

The temperature profile of the film-like melt may be determined, using a contact thermometer or a non-contact thermometer.

For example, the shielding layer may be disposed, for example, on the inner side than both edges of the two rolls and as spaced from the side in the width direction of the thermoplastic resin composition feeding means (e.g., die). The shielding layer may be fixed directly to the side of the feeding means, or may be fixed thereto as supported by a supporting layer. The width of the shielding layer is, for example, preferably the same as or longer than the width of the side of the feeding means in order to efficiently block the ascending air current to be generated by heat radiation by the feeding means.

The gap between the shielding layer and the edge in the width direction of the film-like melt is preferably made narrow for efficiently blocking the ascending air current that runs along the roll surface, more preferably about 50 mm or so from the edge in the width direction of the film-like melt. Not always needed, the gap between the side surface of the feeding means and the shielding layer is preferably such that the air current in the space surrounded by the shielding layer could be discharged therethrough, for example, at most 10 mm.

As the material having a heat-insulating function and/or a heat-reflecting function, preferred is a baffle plate excellent in air shieldability and heat retentiveness, and for example, preferred is a stainless or the like metal plate.

For further reducing the fluctuation of Re[0°], Re[+40°] and Re[−40°], there may be employed a method of increasing the adhesiveness of the film-like melt to the casting roll. Concretely, the adhesiveness may be increased by combining an electrostatic method, an air knife method, an air chamber method, a vacuum nozzle method and the like. The adhesiveness increasing technique may be applied to the entire surface of the film-like melt or may be to a part thereof.

Depending on the temperature of the chill roll, the adhesion of the extruded thermoplastic resin melt to the chill roll may vary. When the temperature of the chill roll is elevated, then the adhesion may be bettered; but when the temperature is too high, then the thermoplastic resin could not peel away from the chill roll and there may occur a failure in that the resin would wind around the chill roll. Accordingly, the chill roll temperature is kept higher than the temperature of the touch roll by from 0.1° C. to 15° C., preferably by from 0.5° C. to 12° C., even more preferably from 1° C. to 10° C. Under the condition, the formed film may be free from the failure of slipping or scratching.

After thus formed, the film-like melt is preferably cooled, using at least one casting roll in addition to the two rolls between which the film is led to pass (e.g., casting roll and touch roll). The touch roll is generally so disposed that it can touch the first casting roll on the most upstream side (nearer to the thermoplastic resin composition feeding means, e.g., die). In general, three cooling rolls are used in a relatively popular method, which, however, is not limitative. The distance between the plural casting rolls is preferably from 0.3 mm to 300 mm as a face-to-face gap therebetween, more preferably from 1 mm to 100 mm, even more preferably from 3 mm to 30 mm.

The number of the cooling drums to be arranged after the chill roll is not specifically defined. In general, it is at least two. The method of cooling drum arrangement is not also specifically defined. For example, the cooling drums may be arranged linearly, or Z-shaped or L-shaped. The method of leading the resin melt, as extruded out through the die orifice, into the cooling drum is not also specifically defined.

Preferably, the processed film is trimmed on both sides thereof. The part trimmed away from the film may be recycled as a film-forming material. Also preferably, the film is knurled on one side or both sides thereof. The height of the knurl formed by the knurling treatment is preferably from 1 μm to 50 μm, more preferably from 3 μm to 20 μm. In the knurling treatment, a protrusion may be formed on one surface or both surfaces. The width of the knurl is preferably from 1 mm to 50 mm, more preferably from 3 mm to 30 mm. The knurling treatment may be carried out at room temperature to 300° C.

Also preferably, a laminate film is attached to one surface or both surfaces of the film before winding it. The thickness of the laminate film is preferably from 5 μm to 100 μm, more preferably from 10 μm to 50 μm. Not specifically defined, its material may be any of polyethylene, polyester, polypropylene, etc.

The tension for winding the film is preferably from 2 kg/m-width to 50 kg/m-width, more preferably from 5 kg/m-width to 30 kg/m-width.

### [Thickness]

The overall thickness of all the layers of the thus-produced, unstretched film is preferably from 10 μm to 150 μm, more preferably from 20 μm to 100 μm, even more preferably from 25 μm to 70 μm. When the thickness is not lower than the lowermost limit of the range, it is favorable since the gap between the touch roll and the chill roll may not be too narrow, and the melt could be given a sufficient turbulent flow between them. On the other hand, when the thickness is not larger than the uppermost limit of the range, then it is also favorable since the melt may not be too thick and may be given a sufficient turbulent flow. On the other hand, for use in liquid crystal displays, the thickness of the film is more preferably at most 80 μm from the viewpoint of display body thickness reduction, even more preferably at most 60 μm, still more preferably at most 40 μm.

### <Stretching, Relaxation>

After formed according to the above-mentioned method, the film may be stretched and/or relaxed. For example, the film may be processed according to the following process (a) to (g).

(a) Lateral stretching
(b) Lateral stretching→relaxation
(c) Longitudinal stretching
(d) Longitudinal stretching→relaxation
(e) Longitudinal (lateral) stretching→lateral (longitudinal) stretching
(f) Longitudinal (lateral) stretching→lateral (longitudinal) stretching→relaxation
(g) Lateral stretching→relaxation→longitudinal stretching→relaxation

Preferably, the production method of the invention includes a step of stretching the film-like shaped, thermoplastic resin-containing composition in at least one direction, from the viewpoint of reducing the formed scratches and further improving the surface condition of the resulting film.

Of those, especially preferred are the processes (a) or (b).

The longitudinal stretching may be attained by leading the film to pass between two pairs of rolls under heat while the peripheral speed of the rolls on the outlet port side is made higher than that of the rolls on the inlet port side. In this stage, the retardation expressibility in the thickness direction of the film may be controlled by changing the distance between the rolls (L) and the width of the unstretched film (W). When L/W (referred to as an aspect ratio) is from 2 to 50 (long-spun stretching), films having a small Rth are easy to produce; and when L/W is from 0.01 to 0.3 (short spun), then films having a large Rth may be produced. Embodiments in this invention, any of long-spun stretching, short-spun stretching, stretching in the range between the two (middle stretching, L/W is from more than 0.3 to 2) may be employed; but preferred are long-spun stretching and short-spun stretching in which the alignment angle can be reduced. More preferably, the stretching modes are differentiated to the effect that short-spun stretching is employed for producing films having a high Rth, and long-spun stretching is employed for producing films having a low Rth.

The stretching temperature is preferably from (Tg−20)° C. to (Tg+30)° C., more preferably from (Tg−15)° C. to (Tg+20)° C., even more preferably from (Tg−10)° C. to (Tg+10)° C. Also preferably, the longitudinal draw ratio is from 1.2 to 3.0 times, more preferably from 1.2 to 2.5 times, even more preferably from 1.2 to 2.0 times.

After stretched, the film may be further processed for relaxation to enhance the dimensional stability thereof. After the film formation, the thermal relaxation may be attained after any of longitudinal stretching or lateral stretching, but preferably every after the two. The relaxation may be attained on-line continuously after stretching, but may be off-line after the stretched film is wound up.

Preferably, the thermal relaxation is attained at from (Tg−30)° C. to (Tg+10)° C., more preferably from (Tg−10)° C. to (Tg+5)° C., even more preferably from (Tg−10)° C. to (Tg+3)° C., preferably for 1 seconds to 10 minutes, more preferably for 5 seconds to 4 minutes, even more preferably for 10 seconds to 2 minutes, while conveyed under tension of preferably from 0.1 kg/m to 20 kg/m, more preferably from 1 kg/m to 16 kg/m, even more preferably from 2 kg/m to 12 kg/m.

In the production method of the invention, especially preferred is stretching the plastic film by a tenter.

A tenter may be used for lateral stretching. Specifically, both sides in the width direction of the film are held with clips, and the film is expanded in the lateral direction. In this case, air at a predetermined temperature may be introduced into the tenter for controlling the stretching temperature. Preferably, the film formed as above is stretched transversely. The transverse stretching may be attained generally using a tenter in which the distance between the chucks is broadened. For example, the following methods may be employed here.

### a) Ordinary Transverse Stretching:

Both side of an unstretched film are held with chucks of a tenter, and while the film in that condition is heated in an oven, the distance between the chucks is expanded to thereby transversely stretch the film. For example, the methods described in the patent publications mentioned below may be employed. Thus transversely stretched, the alignment angle of the slow axis of a positive birefringent resin can be in the stretching direction, while the alignment angle of the slow axis of a negative birefringent resin can be in the direction perpendicular to the stretching direction.

JP-UM-A 62-35817; JP-A 2001-138394, 10-249934, 6-270246, 4-30922, 62-152721.

### b) Simultaneous Biaxial Stretching:

Like in ordinary transverse stretching, the distance between the chucks is expanded in the transverse direction but at the same time, the film is stretched/contracted in the machine direction, and this may be attained by the use of a simultaneous biaxial-stretching tenter-type stretcher. For example, there may be mentioned a pantograph-type tenter stretcher, a screw-type tenter stretcher, a linear motor-type tenter stretcher, etc. Concretely, the methods described in the patent publications mentioned below may be employed. Thus biaxially stretched, the alignment angle of the slow axis of a positive birefringent resin can be in the stretching direction, while the alignment angle of the slow axis of a negative birefringent resin can be in the direction perpendicular to the stretching direction.

JP-UM-A 55-93520; JP-A 63-247021, 6-210726, 6-278204, 2000-334832, 2004-106434, 2004-195712, 2006-142595, 2007-210306, 2005-22087; JP-T 2006-517608; JP-A 2007-210306.

### c) Oblique Stretching:

Like in ordinary transverse stretching, the film held by a pair of chucks is expanded and stretched in the transverse direction while heating, and in this process, the traveling speed of the right and left chucks are change, or the tenter is dogleg-bent, or the length of the right and left chucks is changed (for example, the chuck traveling channel length of one chuck is kept long in the tenter), whereby the film can be stretched in an oblique direction. Accordingly, the stretching direction can be at 45°±10° from MD (machine direction), more preferably at 45°±8°, even more preferably at 45°±5°. Concretely, the apparatus described in the patent publications mentioned below may be employed.

JP-A 2000-9912, 2002-22944, 2002-86554, 2003-342384, 2004-20701, 2004-258508, 2004-325561, 2006-224618, 2006-255892, 2008-23775, 2008-110573, 2008-221834, 2003-342384; WO2003/102639; JP-A 2008-23775.

In the film of the invention, the alignment direction of the slow axis may be in any site, but preferably, the alignment angle as measured from the machine direction is preferably at 90°±10°, 0±10°, or 45°±10°; more preferably at 90°±8°, 0±8°, or 45°±8°; even more preferably at 90°±5°, 0±5°, or 45°±5°; and most preferably at 45°±5°.

The transverse stretching temperature is preferably from Tg−30° C. to Tg+40° C., more preferably from Tg−20° C. to Tg+30° C., even more preferably from Tg−10° C. to Tg+25° C.; and the draw ratio in stretching is preferably from 1.05 times to 3 times, more preferably from 1.1 times to 2.6 times, even more preferably from 1.2 times to 2.3 times.

The preferred stretching speed (clip traveling speed) may be suitably selected, but in general, the speed is preferably from 10 to 100 m/min, more preferably from 15 to 60 m/min.

Before stretched, the film may be preheated, and after stretched, it may be thermally fixed, whereby the Re and/or Rth fluctuation in the stretched film may be reduced and the alignment angle fluctuation with bowing can be reduced. Any one of preheating and thermal fixation may be attained, but preferably, these are both attained. In preheating and thermal fixation, preferably, the film is held with clips, or that is, it is desirable that the preheating, the stretching and the thermal fixation of the film are attained continuously.

The preheating temperature is preferably from (Tg−5)° C. to (Tg+40)° C., more preferably from Tg ° C. to (Tg+30)° C. The preheating temperature may also be higher by from 1° C. to 50° C. or so than the stretching temperature, and is preferably higher by from 2° C. to 40° C., more preferably by from 3° C. to 30° C. Preferably, the heating time is from 1 second to 10 minutes, more preferably from 5 seconds to 4 minutes, even more preferably from 10 seconds to 2 minutes. During the preheating, the tenter width is preferably kept nearly constant. The wording “nearly” is meant to indicate ±10% of the width of the unstretched film.

The thermal fixation temperature is preferably from (Tg−5)° C. to (Tg+25)° C., more preferably from Tg ° C. to (Tg+15)° C. The thermal fixation may be attained at a temperature lower by from 1° C. to 50° C. than the stretching temperature, more preferably lower by from 2° C. to 40° C., even more preferably by from 3° C. to 30° C. Still more preferably, the thermal fixation temperature is not higher than the stretching temperature and not higher than Tg. The time of the thermal fixation is preferably from 1 second to 10 minutes, more preferably from 5 seconds to 4 minutes, even more preferably from 10 seconds to 2 minutes. During the thermal fixation, the tenter width is preferably kept nearly constant. The wording “nearly” is meant to indicate a range of from 0% of the tenter width after the stretching treatment (the same width as the tenter width after the stretching treatment) to −10% thereof (smaller by 10% than the tenter width after the stretching treatment=width reduction). When the width of the film is expanded more than the stretched width, then it is unfavorable since residual strain may remain in the film.

The length of the preheating zone, the stretching zone and the fixation zone may be suitably selected; and relative to the length of the stretching zone, the length of the preheating zone may be from 100 to 150%, and that of the fixation zone may be from 50 to 100%.

The preferred stretching speed (clip traveling speed) may be suitably selected, but in general, the speed is preferably from 10 to 100 m/min, more preferably from 15 to 60 m/min.

After stretched, both sides of the film may be trimmed and then knurled, and then the film may be wound up around a winding roll.

Thus stretched, the thickness of the film may be from 10 μm to 90 μm, preferably from 20 μm to 80 μm, more preferably from 25 μm to 70 μm.

### [Polarizer]

A polarizer of the invention includes at least one film of the invention. In the case where the film of the invention includes no polarizing element (hereinafter this may be referred to as “polarizing film”), at least a polarizing element may be laminated on the film of the invention to produce the polarizer of the invention. The polarizer of the invention is described below. Examples of the polarizer of the invention include those produced for the purpose of two functions as a protective film and for viewing angle compensation on one surface of a polarizing film, and composite-type polarizers laminated on a protective film of TAC or the like.

The polarizer of the invention is not specifically defined in point of its constitution, and it may be any one comprising the film of the invention and a polarizing element. For example, the polarizer of the invention comprises a polarizing element and two polarizer-protective films (transparent polymer films) for protecting both surfaces of the element, the film of the invention may be at least one of the polarizer-protective films. The polarizer of the invention may have an adhesive layer via which the polarizer is stuck to any other layer. In the polarizer of the invention, when the surface of the film of the invention has a roughened structure, it may have an antiglare function. Also preferably, the polarizer of the invention may comprise an antireflection film of the invention produced by laminating an antireflection layer (low-refractivity layer) on the surface of a film of the invention, or an optical compensatory film of the invention produced by laminating an optically-anisotropic layer on the surface of a film of the invention.

In general, a liquid crystal display device comprises a liquid crystal cell disposed between two polarizers, which, therefore has four polarizer-protective films. The film of the invention may be any of those four polarizer-protective films, but preferably, the film is especially advantageously used as the protective film to be disposed between the liquid crystal cell and the polarizing element in the liquid crystal display device.

More preferably, the polarizer of the invention has a constitution of a protective film (preferably a cellulose acylate film), a polarizing element and a film of the invention laminated in that order. Also preferred is a constitution of a cellulose acylate film, a polarizing element, a film of the invention and an adhesive layer laminated in that order.

### (Optical Film)

As the optical film in the polarizer of the invention, used is the film of the invention. The film may be surface-treated. The surface treatment method includes, for example, corona discharge, glow discharge, UV irradiation, flame treatment, etc.

### (Protective Film)

In general, a protective film is stuck to both sides of the polarizing element to provide a polarizer.

As the protective film for the polarizer, at least one film of the invention may be used, and in addition to it, any suitable transparent film may be used. Above all, preferred are polymer films excellent in transparency, mechanical strength, heat stability and moisture shielding capability. Examples of the polymer are alicyclic structure-having polymers, polyolefin polymers, polycarbonate polymers, polyester polymers such as polyethylene terephthalate, polyvinyl chloride polymers, polystyrene polymers, polyacrylonitrile polymers, polysulfone polymers, polyether sulfone polymers, polyarylate polymers, acetate polymers such as triacetyl cellulose, (meth)acrylate/vinyl aromatic compound copolymers, etc. From the viewpoint of transparency and weight saving, especially preferred are triacetyl cellulose, polyethylene terephthalate, and alicyclic structure-having polymer resins; and from the viewpoint of dimensional stability and thickness control, more preferred are polyethylene terephthalate and alicyclic structure-having polymer resins. Further, the optical anisotropic material for use in the invention may serve also as the protective film for the polarizing element, and this contributes toward reducing the thickness of liquid crystal display devices.

Concretely, the alicyclic structure-having polymer resins include norbornene polymers, monocyclic olefinic polymers, cyclic conjugated diene polymers, vinyl alicyclic hydrocarbon polymers, and their hydrogenated derivatives. Of those, preferred are norbornene polymers from the viewpoint of transparency and shapability.

The norbornene polymers concretely include norbornene monomer ring-opened polymers, ring-opened copolymers of norbornene monomer and other ring-opening copolymerizable monomer, and their hydrogenated derivatives; norbornene monomer addition-polymerized polymers, addition-polymerized copolymers of norbornene monomer and other copolymerizable monomer. Of those, most preferred are hydrogenated derivatives of norbornene ring-opened (co)polymers from the viewpoint of transparency.

The alicyclic structure-having polymer resins are selected from known polymers described in, for example, JP-A 2002-321302.

As the protective film in the polarizer of the invention, used is any known cellulose acylate film for polarizer. For example, known triacetyl cellulose (TAC) films (e.g., FUJIFILM Corporation's Fujitac T-60, TD80UL) are preferred. The cellulose acylate film may be surface-treated. The surface treatment method includes, for example, saponification, etc.

### (Polarizing Element)

As the polarizing element, for example, used is one produced by dipping a polyvinyl alcohol film in an iodine solution followed by stretching it.

Any one capable of attaining the intended object of the invention may be selected form the polarizing element for use in the invention. The polarizing element includes, for example, those produced by making a hydrophilic polymer film adsorb a dichroic substance such as iodine or dichroic dye followed by uniaxially stretching it and polyene-based oriented films; such as dehydrated polyvinyl alcohol films, dehydrochlorinated polyvinyl chloride films, etc.

Herein usable are those produced by processing films of suitable vinyl alcohol polymers such as polyvinyl alcohol or partially-formalized polyvinyl alcohol or the like through dyeing with a dichroic substance such as iodine or a dichroic dye, stretching, crosslinking and the like in any desired order according to a suitable method, and those capable of transmitting linearly-polarized light when natural light is applied thereto.

The hydrophilic polymer film includes, for example, polyvinyl alcohol films, partially formalized polyvinyl alcohol films, partially saponified ethylene/vinyl acetate copolymer films, etc. In the invention, preferred is a polarizing element produced by making a polyvinyl alcohol film adsorb iodine.

Preferably, the polarizing element further contains at least one of potassium and boron. Containing potassium and/or boron, the polarizing element may have a complex elastic modulus (Er) within a preferred range, and may have a high degree of polarization or may give a polarizer having a high degree of polarization. For producing the polarizing element containing at least one of potassium and boron, for example, the film to be the polarizing element may be dipped in at least one solution of potassium and boron. The solution may contain iodine.

As the polarizing element for use in the liquid crystal display device of the invention, especially preferred is one excellent in the light transmittance and the degree of polarization. The thickness of the polarizing element may be generally from 5 to 80 μm, to which, however, the invention is not limited.

For producing the polyvinyl alcohol film, any suitable working method is employable. The working method may be a known one. Commercial films may be directly used for the polyvinyl alcohol film. Commercial polyvinyl alcohol films include, for example, “Kuraray Vinylon Film” (KURARAY CO., LTD.'s trade name), “Tohcello Vinylon Film” (Tohcello Co. Ltd.'s trade name), “Nichigo Vinylon Film” (Nippon Gohsei's trade name), etc.

One example of producing a polarizing element is described. For example, a polyvinyl alcohol-based polymer film (unprocessed film) is dipped in a swelling bath of pure water and in a dyeing bath of an aqueous iodine solution, in which the film is swollen and dyed under tension given thereto in the machine direction by rolls each running at a different speed. Next, the thus-swollen and dyed film is dipped in a crosslinking bath containing potassium iodine and is thus crosslinked and finally stretched under tension given thereto in the machine direction by rolls each running at a different speed. The crosslinked film is dipped in a water bath of pure water, as conveyed by rolls, and is thus rinsed with water. The rinsed film is then dried to have a controlled water content and wound up. In that manner, the polarizing element is produced by stretching the starting film, for example, by from 5 times to 7 times the original length thereof.

The polarizing element may be processed for surface modification in any desired manner, for enhancing its compatibility with adhesive. The surface modification treatment includes, for example, corona discharge, plasma discharge, glow discharge, flame treatment, ozone treatment, UV ozone treatment, UV treatment, etc. One or more of these treatments may be applied to the polarizing element either singly or as combined.

### (Adhesive Layer)

The polarizer of the invention may have an adhesive layer as at least one outermost layer thereof (the polarizer of the type may be referred to as “adhesive polarizer”). In one preferred embodiment, an adhesive layer is provided on the surface of the optical film opposite to the surface thereof stuck to the above-mentioned polarizing element, which is for facilitating adhesion of the polarizer to any other layer such as any other optical film, liquid crystal cell, etc.

### (Production Method for Polarizer)

A method for producing the polarizer of the invention is described.

The polarizer of the invention may be produced by sticking one surface (with surface treatment, if any) of a film of the invention to at least one surface of the above-mentioned polarizing element with an adhesive. In case where a cellulose acylate film, a polarizing element of the invention and a film of the invention are stuck together in that order to produce a polarizer of the invention, an adhesive may be applied to both surfaces of the polarizing element and the polarizing element may be stuck to the other films. In the production method for the polarizer of the invention, preferably, the film of the invention is directly stuck to the polarizing element.

As the lamination method, herein employable is any known method. For example, there are mentioned a method of cutting the optical anisotropic material and the polarizing element into pieces each having a suitable size and laminating them; and a method of laminating a long optical anisotropic material and a long polarizing element according to a roll-to-roll process.

In the invention, in case where the film of the invention is kept in contact with the polarizing element, the optical anisotropic material may be replaced for the protective film for the polarizing element and they may be stuck together according to a suitable means of using an adhesive agent or a sticky paste.

The adhesive agent may be a known adhesive agent for polarizer production. Also preferred is an embodiment where an adhesive layer is arranged between the polarizing element and the film. As the adhesive agent or the sticky paste, for example, there are mentioned acrylic materials, silicone materials, polyester materials, polyurethane materials, polyether materials, rubber materials, etc.

Examples of the adhesive include aqueous solution of polyvinyl alcohol or polyvinyl acetal (e.g., polyvinyl butyral), and latex of vinylic polymer (e.g., polybutyl acrylate). An aqueous solution of completely saponified polyvinyl alcohol is especially preferred for the adhesive. Preferably, the polyvinyl alcohol adhesive contains a polyvinyl alcohol resin and a crosslinking agent.

The production method for the polarizer of the invention is not limited to the above-mentioned methods, and any other methods are employable. For example, herein employable are the methods described in JP-A 2000-171635, 2003-215563, 2004-70296, 2005-189437, 2006-199788, 2006-215463, 2006-227090, 2006-243216, 2006-243681, 2006-259313, 2006-276574, 2006-316181, 2007-10756, 2007-128025, 2007-140092, 2007-171943, 2007-197703, 2007-316366, 2007-334307, 2008-20891. Of those, more preferred are the methods described in JP-A 2007-316366, 2008-20891.

Preferably, a protective film is stuck to the other surface of the polarizing film, and the protective film may be a film of the invention. Also usable are various films heretofore known as protective films for polarizers, such as cellulose acylate films, cyclic polyolefin polymer films, etc.

Thus produced, the polarizer of the invention is preferably used in a liquid crystal display device, in which the polarizer may be on any side of the viewing side or the backlight side of the liquid crystal cell, or may be on both sides thereof with no limitation. Specific examples of image-display devices to which the polarizer of the invention is applicable include self-emitting display devices such as electroluminescent (EL) displays, plasma displays (PD), field emission displays (FED). The liquid crystal display device to which the polarizer is applicable includes transmission-type liquid crystal display devices and reflection-type liquid crystal display devices.

The film of the invention may be used as an optical compensatory film for TN (twisted nematic) mode liquid crystal display devices. In a TN-mode liquid crystal layer, the molecules are kept standing obliquely in the thickness direction of the layer, and for compensating the molecules, the film of the invention is effective based on the tilt structure thereof.

### [Liquid Crystal Display Device]

The film and the polarizer of the invention may be used in liquid crystal display devices with various display modes. The film and the polarizer of the invention is preferably used with the liquid crystal display mode of TN (Twisted Nematic), IPS (In-Plane Switching), OCB (Optical compensatory Bend) and ECB (Electrically Controlled Birefringence), and among them, the film and the polarizer of the invention is more preferably used with that of TN and IPS mode.

The liquid crystal display device of the invention comprises at least one film of the invention.

Preferably, the liquid crystal display device comprises at least the film of the invention (this is a negative birefringent layer), a positive birefringent layer and a liquid crystal cell between a pair of polarizing elements, in which one is a light-going side polarizing element and the other is a light-coming side polarizing element, and the two are so positioned that their absorption axes are perpendicular to each other. Preferably in the liquid crystal display device, the in-plane slow axis of the negative birefringent layer and the in-plane slow axis of the positive birefringent layer are nearly parallel to or nearly perpendicular to each other, and the in-plane slow axis of the negative birefringent layer is nearly parallel to or nearly perpendicular to the absorption axis of the polarizing element arranged in the vicinity of the layer.

In the invention, the angle (smaller angle) between two axes means the angle between the planes that individually have the two axes as the normal lines. In the invention, two axes that are nearly parallel to each other means that the angle between the two axes is from 0 to 3°. In the invention, two axes that are nearly perpendicular to each other means that the angle between the two axes is from 87 to 90°.

In the in-plane switching (IPS) mode, a type of the mode of the liquid crystal display device of the invention, used are liquid crystal molecules homogeneously aligned in the horizontal direction, and two polarizing elements of which the transmission axes are perpendicular to each other both in the vertical direction and in the horizontal direction relative to the display panel; and in this, therefore, the two transmission axes are perpendicular to each other when the panel is seen in the oblique direction relative to the horizontal direction and the vertical direction, and since the homogeneous alignment liquid crystal layer has little birefringence as opposed to that in a twisted mode liquid crystal layer, the display device of this mode secures a sufficient contrast. As opposed to this, in case where the display panel is seen in the direction at an azimuth angle of 45°, the angle between the transmission axes of the two polarizing elements are shifted from 90°, and in this condition, therefore, the transmitted light provides birefringence and brings about light leakage, and as a result, a sufficient black level of display could not be secured and the contrast is lowered. Accordingly, between the two polarizing elements in the in-plane switching mode liquid crystal display device, a negative birefringent layer and a positive birefringent layer are arranged in such a manner that the in-plane slow axis of the negative birefringent layer and the in-plane slow axis of the positive birefringent layer are nearly parallel to each other and that the in-plane slow axis of the negative birefringent layer and the transmission axis of the polarizing element adjacent to the layer are nearly parallel or nearly perpendicular to each other, whereby the retardation to be generated by the liquid crystals in the liquid crystal layer can be compensated and, in addition, the viewing angle of the polarizing elements can also be compensated. Accordingly, the retardation occurring with the transmitted light can be effectively compensated and the light leakage can be thereby prevented, and the display device secures a high contrast in all directions. The same effect would apply to other modes of liquid crystal display devices, and especially the effect is remarkable in IPS mode devices.

### [HC]

The protective film for the polarizing element at the side of vision in the liquid crystal display device of the present invention can be prepared by laminating a hard coat layer and a low refractive index layer in this order.

The hard coat layer is a layer having a great hardness of the surface. Specifically, the hard coat layer is a layer having a hardness of “HB” or harder measured in accordance with the test method of pencil hardness (using a glass plate as the test plate) described in Japanese Industrial Standard K 5600-5-4. It is preferable that the hard coat layer has a great refractive index. When the hard coat layer has a great refractive index, formation of images due to outside light can be prevented, and a polarizer exhibiting excellent scratch resistance and property for preventing fouling can be prepared. The average thickness of the hard coat layer is not particularly limited. The thickness is, in general, 0.5 to 30 μm and preferably 3 to 15 μm. The great refractive index means a refractive index greater than the refractive index of the low refractive index layer which will be laminated later and is preferably 1.55 or greater. The refractive index can be obtained by using, for example, a conventional spectro-elipsometer.

The material for constituting the hard coat layer is not particularly limited as long as the material exhibits a hardness of “HB” or harder measured in accordance with the test method of pencil hardness (using a glass plate as the test plate) described in Japanese Industrial Standard K 5600-5-4.

Examples of the above material include organic hard coat materials such as organic silicone-based materials, melamine-based materials, epoxy-based materials, acrylic materials and urethane acrylate-based materials; and inorganic hard coat materials such as silicon dioxide-based materials. Among these materials, urethane acrylate-based hard coat materials and polyfunctional acrylate-based hard coat materials are preferable from the standpoint of excellent adhesive ability and productivity.

In the present invention, it is preferable that the hard coat layer has a refractive index of 1.5 or greater, more preferably 1.53 or greater and most preferably 1.55 or greater. When the refractive index of the hard coat layer is in this range, an excellent property of preventing reflection in a wide band range is exhibited, the design of the low refractive index layer to be laminated on the hard coat layer is facilitated, and a laminate film for optical applications exhibiting excellent scratch resistance can be obtained.

It is preferable that the hard coat layer further comprises particles of an inorganic oxide.

By adding particles of an inorganic oxide, a hard coat layer exhibiting excellent scratch resistance and having a refractive index of 1.55 or greater can be easily formed.

As the particles of an inorganic oxide which can be used for the hard coat layer, particles having a great refractive index are preferable. Specifically, particles of an inorganic oxide having a refractive index of 1.6 or greater are preferable, and particles of an inorganic oxide having a refractive index of 1.6 to 2.3 are more preferable.

Examples of the particles of an inorganic oxide having a great refractive index include particles of titania (titanium oxide), zirconia (zirconium oxide), zinc oxide, tin oxide, cerium oxide, antimony pentaoxide, indium oxide doped with tin (ITO), tin oxide doped with antimony (ATO), tin oxide doped with phosphorus (PTO), indium oxide doped with zinc (IZO), zinc oxide doped with aluminum (AZO) and tin oxide doped with fluorine (FTO).

Among these particles, particles of antimony pentaoxide are suitable as a component for adjusting the refractive index due to the great refractive index and excellent balance between electric conductivity and transparency.

The low refractive index layer is a layer having a refractive index smaller than that of the hard coat layer. The refractive index of the low refractive index layer is preferably 1.36 or smaller, more preferably 1.35 to 1.25, and most preferably 1.34 to 1.30. When the refractive index is within the above range, a protective film for a polarizer exhibiting excellent balance between visibility, scratch resistance and strength can be formed. The thickness of the low refractive index layer is preferably 10 to 1,000 nm and more preferably 30 to 500 nm.

The material constituting the low refractive index layer is not particularly limited as long as the layer having a refractive index within the above range can be formed. Aero gel is preferable since the control of the refractive index is easy and water resistance is excellent.

The aero gel is a transparent porous substance having minute pores dispersed in a matrix. Most of the pores have a size of 200 nm or smaller. The content of the pore is, in general, 10% by volume or greater and 60% by volume or smaller and preferably 20% by volume or greater and 40% by volume or smaller. Examples of the aero gel having dispersed minute pores include silica aero gel and porous substances containing hollow particles dispersed in a matrix.

The aero gel can be produced by supercritical drying of a gel-form compound which is obtained by polymerization of an alkoxysilane with hydrolysis, has a skeleton structure of silica and is in the swollen condition, as disclosed in the U.S. Pat. Nos. 4,402,927, 4,432,956 and 4,610,863. The supercritical drying can be conducted, for example, by replacing a portion or the entire amount of a solvent in a gel-form compound with a drying fluid such as carbon dioxide and an alcohol, followed by bringing the resultant compound into a supercritical condition and removing the drying fluid (as a gas) which has changed into the gas phase from the supercritical condition. The silica aero gel may be produced using sodium silicate as the raw material in a manner described above as disclosed in the U.S. Pat. Nos. 5,137,279 and 5,124,364. The refractive index of the silica aero gel can be changed as desired by adjusting relative amounts of raw materials.

Examples of the porous substances containing hollow particles dispersed in a matrix include porous substances in which hollow fine particles having pores at the inside are dispersed in a binder resin as disclosed in JP-A 2001-233611 and JP-A 2003-149642.

The binder resin can be selected from resins satisfying requirements such as dispersion of hollow fine particles, transparency of the porous substance and strength of the porous substance. Examples of the binder resin include conventional resins used for coating such as polyester resins, acrylic resins, urethane resins, vinyl chloride resins, epoxy resins, melamine resins, fluororesins, silicone resins, butyral resins, phenol resins, vinyl acetate resins, ultraviolet light curable resins, electron beam curable resins, emulsion resins, water-soluble resins, hydrophilic resins, mixtures of these resins and copolymers and modified substances of these resins; and hydrolyzable organic silicon compounds such as alkoxysilanes and hydrolysis products thereof.

Among the above resins, acrylic resins, epoxy resins, urethane resins, silicone resins, hydrolyzable organic silicon compounds such as alkoxysilanes and hydrolysis products thereof are preferable from the standpoint of dispersion of the fine particles and strength of the porous substance.

The hydrolyzable organic silicon compound such as alkoxysilanes and hydrolysis products thereof are formed from one or more compounds selected from the group consisting of compounds (a) and products (b) and (c) shown in the following:

(a) Compounds represented by formula (3):

SiX4 (3)

(b) Products of partial hydrolysis of at least one of compounds represented by formula (3)
(c) Products of complete hydrolysis of at least one of compounds represented by formula (3)
and have a bond represented by —(O—Si)ₘ—O— (m representing a natural number) in the molecule.

The hollow fine particles are not particularly limited as long as the particles are fine particles of an inorganic compound. Inorganic fine particles having a hollow formed at the inside of an outer shell are preferable, and silica-based hollow fine particles are more preferable. As the inorganic hollow fine particles, particles having (A) a single layer of an inorganic oxide, (B) a single layer of a complex oxide comprising inorganic oxides of different types and (C) a double layer comprising layers (A) and (B) described above can be used.

The outer shell may be a porous shell having fine open pores or a closed shell having no open pores so that the hollow at the inside is shielded from the outside of the shell. As the outer shell, a coating layer comprising a plurality of coating layers of an inorganic oxide which comprises an inner first coating layer of an inorganic oxide and an outer second coating layer of an inorganic oxide is preferable. By disposing the outer second coating layer of an inorganic oxide at the outside, the outer shell can be made dense by closing pores of the outer shell, or inorganic hollow fine particles having a hollow completely shielded from the outside can be obtained. It is preferable that an organic silicon compound having fluorine atom is used for forming the outer second coating layer comprising an inorganic oxide since the refractive index can be decreased, dispersion into organic solvents can be improved, and the property of preventing fouling can be provided. Examples of the organic silicon compound having fluorine atom include 3,3,3-trifluoropropyltrimethoxy-silane, methyl-3,3,3-trifluoropropyldimethoxysilane, heptadecafluoro-decylmethyldimethoxysilane, heptadecafluorodecyltrichlorosilane, heptadecafluorodecyltrimethoxysilane, trifluoropropyltrimethoxysilane and tridecafluorooctyltrimethoxysilane.

The thickness of the outer shell is preferably in the range of 1 to 50 nm and more preferably in the range of 5 to 20 nm. When the thickness of the outer shell is smaller than 1 nm, there is the possibility that the inorganic hollow fine particles cannot maintain the prescribed shape. When the thickness of the outer shell exceeds 50 nm, the hollow at the inside of the inorganic hollow particles is small. As the result, there is the possibility that the relative volume of the hollow is decreased, and the decrease in the refractive index is insufficient.

The average diameter of the inorganic fine particles is not particularly limited. The average diameter is preferably 5 to 2,000 nm and more preferably 20 to 100 nm. When the average diameter is smaller than 5 nm, the effect of the hollows to decrease the refractive index is small. When the average diameter exceeds 2,000 nm, transparency extremely deteriorates, and the contribution of diffusion and reflection increases. The average diameter of the fine particles is the number-average diameter obtained by the observation using a transmission electron microscope.

The protective film for the polarizing element at the side of vision has a maximum reflectance of light having wavelengths in the range of 430 to 700 nm of preferably 1.4% or smaller and more preferably 1.3% or smaller at an incident angle of 5°. The reflectance of light having a wavelength of 550 nm is preferably 0.7% or smaller and more preferably 0.6% or smaller at an incident angle of 5°.

The maximum reflectance of light having wavelengths in the range of 430 to 700 nm is preferably 1.5% or smaller and more preferably 1.4% or smaller at an incident angle of 20°, and the reflectance of light having a wavelength of 550 nm is preferably 0.9% or smaller and more preferably 0.8% or smaller at an incident angle of 20°.

When each reflectance is within the respective range described above, a polarizer showing no images from outside light or glare and providing excellent vision can be obtained.

As for the reflectance described above, the reflectance of light having a wavelength of 550 nm and the maximum reflectance of light having wavelengths in the range of 430 to 700 nm are obtained at incident angles of 5° and 20° using a spectrophotometer (an ultraviolet, visible and near infrared spectrophotometer V-550; manufactured by NIPPON BUNKO Co., Ltd.).

The steel wool test is conducted by reciprocally moving steel wool #0000 ten times on the surface of a protective film of a polarizer at the side of vision under application of a load of 0.025 MPa, and then the change in the condition of the surface after the test is measured.

For evaluation of the change in the reflectance before and after the steel wool test, the measurement is conducted at arbitrarily selected 5 different positions on the surface before and after the test, and the arithmetic average of the obtained values is calculated.

In the above steel wool test, the change in the reflectance on the protective film of a polarizer at the side of vision before and after the test is preferably 10% or smaller and more preferably 8% or smaller. When the change in the reflectance exceeds 10%, blurred images may be formed or glare may arise.

The change in the reflectance before and after the steel wool test is obtained in accordance with the following equation (1.1). Rb represents the reflectance before the steel wool test, and Ra represents the reflectance after the steel wool test.

ΔR=(Rb−Ra)/Rb× 100(%) (1.1)

The embodiments of the liquid crystal display device of the present invention comprising the negative birefringence layer and the positive birefringence layer comprise 12 embodiments of the preferable arrangement. In the following, 6 embodiments of the preferable arrangement in which “the polarizing element of the output side” is placed at the side of vision, and “the polarizing element of the incident side” is placed at the side of the back light will be described. The remaining 6 embodiments of the preferable arrangement are embodiments of the preferable arrangement obtained by exchanging the polarizing element at the side of vision and the polarizing element at the side of the back light with each other (i.e., the arrangement in which “the polarizing element of the incident side” is placed at the side of vision, and “the polarizing element of the output side” is placed at the side of the back light). These embodiments of the preferable arrangement show the same characteristics of the angle of field with those before the exchange of the polarizing element at the side of vision and the polarizing element at the side of the back light with each other. For example, the embodiments of the arrangement obtained by exchanging the polarizing element at the side of vision and the polarizing element at the side of the back light with each other show the same characteristics of the angle of field with respect to luminance, contrast and color tone. The arrow in the figures shows the absorption axis for the polarizing elements (1: the polarizing element at the incident side; 5: the polarizing element at the output side), the in-plane slow axis under application of no voltage for the liquid crystal cell 2, and the in-plane slow axis for the optically anisotropic layers (3: the negative birefringence layer; 4: the positive birefringence layer).

In the first and second embodiments of the preferable arrangement, the negative birefringence layer and the positive birefringence layer are disposed between the polarizing element at the incident side (the polarizing element at the side of the back light) and the liquid crystal cell of the liquid crystal display device.

### (I-1) The First Embodiment of the Preferable Arrangement

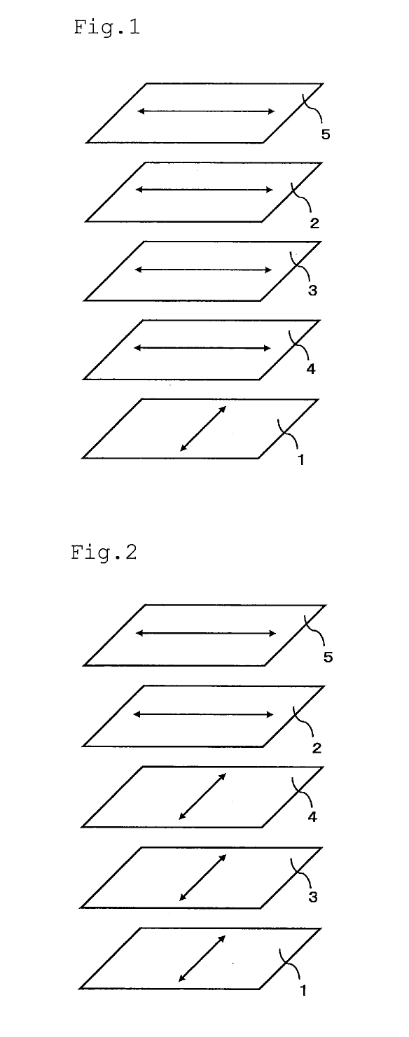

FIG. 1 shows a diagram exhibiting the first embodiment of the preferable arrangement (referred to as arrangement I-1, hereinafter) of the liquid crystal display device of the present invention. In arrangement I-1, the absorption axis of the polarizing element at the output side and the in-plane slow axis of the liquid crystal of the liquid crystal cell under application of no voltage are disposed at relative positions parallel to each other. The in-plane slow axes of the negative birefringence layer and the positive birefringence layer are disposed at relative positions approximately parallel to each other. It is preferable that the in-plane slow axis of the positive birefringence layer and the in-plane slow axis of the liquid crystal of the liquid crystal cell under application of no voltage are disposed at relative positions approximately parallel to each other, and the negative birefringence layer is disposed at a position closer to the liquid cell than the positive birefringence layer. Due to the above relative positions of the negative birefringence layer, the positive birefringence layer, the liquid crystal cell and the two polarizing elements, the minimum value of the contrast can be made 30 or greater at polar angles of 0 to 80°.

In arrangement I-1, the preferable combination of the in-plane retardation Re(A) (the unit: nm) and the retardation in the direction of the thickness Rth(A) (the unit: nm) of the negative birefringence layer and the in-plane retardation Re(B) (the unit: nm) and the retardation in the direction of the thickness Rth(B) (the unit: nm) of the positive birefringence layer is: 10≦Re(A)≦1,000, −500≦Rth(A)≦−5, 10≦Re(B)≦500 and 5≦Rth(B)≦250. The more preferable combinations are: (1) 10≦Re(A)≦360, −180≦Rth(A)≦−5, 10≦Re(B)≦360 and 5≦Rth(B)≦360; (2) 350≦Re(A)≦470, −235≦Rth(A)≦−175, 450≦Re(B)≦500 and 225 Rth(B)≦250; and (3) 640≦Re(A)≦700, −350≦Rth(A)≦−320, 20≦Re(B)≦100 and 10≦Rth(B)≦50. The still more preferable combination is: 30≦Re(A)≦320, −160≦Rth(A)≦−15, 30≦Re(B)≦320 and 20≦Rth(B)≦−320. The most preferable combination is: 70≦Re(A)≦120, −65≦Rth(A)≦−25, 50≦Re(B)≦110 and 25≦Rth(B)≦70.

In the present invention, the in-plane retardation Re and the retardation in the direction of thickness Rth can be obtained in accordance with the following equations (1.2) and (1.3). In the equations, nx, ny and nz each represent the refractive index (−), and d represents the thickness (nm).

Re=(nx−ny)×d (1.2),

Rth=[(nx+ny)/2−nz]×d (1.3).

### (I-2) The Second Embodiment of the Preferable Arrangement

FIG. 2 shows a diagram exhibiting the second embodiment of the preferable arrangement (referred to as arrangement I-2, hereinafter) of the liquid crystal display device of the present invention. In arrangement I-2, the absorption axis of the polarizing element at the output side and the in-plane slow axis of the liquid crystal of the liquid crystal cell under application of no voltage are disposed at relative positions parallel to each other. The in-plane slow axes of the negative birefringence layer and the positive birefringence layer are disposed at relative positions approximately parallel to each other. It is preferable that the in-plane slow axis of the positive birefringence layer and the in-plane slow axis of the liquid crystal of the liquid crystal cell under application of no voltage are disposed at relative positions approximately perpendicular to each other, and the positive birefringence layer is disposed at a position closer to the liquid cell than the negative birefringence layer. Due to the above relative positions of the negative birefringence layer, the positive birefringence layer, the liquid crystal cell and the two polarizing elements, the minimum value of the contrast can be made 30 or greater at polar angles of 0 to 80°.

In arrangement I-2, the preferable combination of the in-plane retardation Re(A) (the unit: nm) and the retardation in the direction of the thickness Rth(A) (the unit: nm) of the negative birefringence layer and the in-plane retardation Re(B) (the unit: nm) and the retardation in the direction of the thickness Rth(B) (the unit: nm) of the positive birefringence layer is: 10≦Re(A)≦1,000, −500≦Rth(A)≦−5, 10≦Re(B)≦1,000 and 5≦Rth(B)≦500. The more preferable combinations are: (1) 10≦Re(A)≦310, −240≦Rth(A)≦−5, 10≦Re(B)≦300 and 5≦Rth(B)≦100; (2) 350≦Re(A)≦470, −235≦Rth(A)≦−175, 450≦Re(B)≦500 and 225≦Rth(B)≦250; (3) 640≦Re(A)≦700, −350≦Rth(A)≦−320, 20≦Re(B)≦100 and 10≦Rth(B)≦50; and (4) 730≦Re(A)≦760, −570≦Rth(A)≦−540, 240≦Re(B)≦280 and 120≦Rth(B)≦140. The still more preferable combination is: 30≦Re(A)≦150, −90≦Rth(A)≦−15, 40≦Re(B)≦150 and 20≦Rth(B)≦75. The most preferable combination is: 60≦Re(A)≦110, −70≦Rth(A)≦−25, 70≦Re(B)≦120 and 25≦Rth(B)≦65.

In the third and fourth embodiments of the preferable arrangement, the negative birefringence layer and the positive birefringence layer are disposed between the polarizing element at the output side (the polarizing element at the side of vision) and the liquid crystal cell of the liquid crystal display device.

### (II-1) The Third Embodiment of the Preferable Arrangement

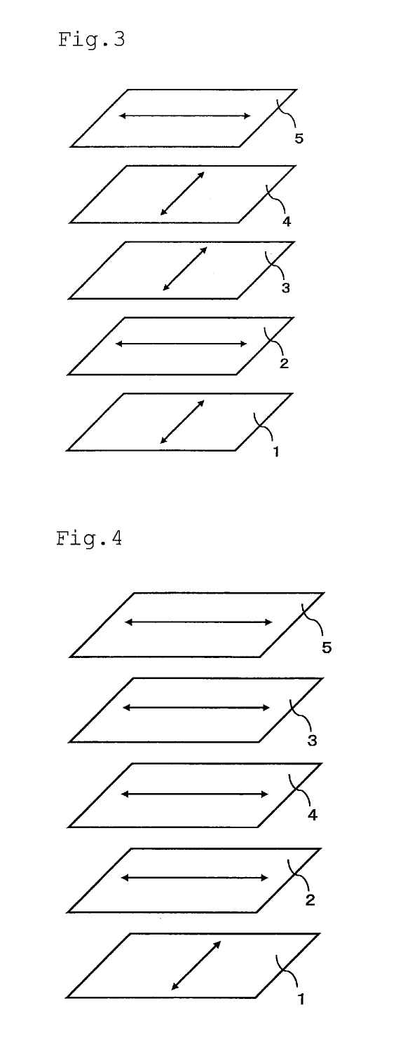

FIG. 3 shows a diagram exhibiting the third embodiment of the preferable arrangement (referred to as arrangement II-1, hereinafter) of the liquid crystal display device of the present invention. In arrangement II-1, the absorption axis of the polarizing element at the output side and the in-plane slow axis of the liquid crystal of the liquid crystal cell under application of no voltage are disposed at relative positions parallel to each other. The in-plane slow axes of the negative birefringence layer and the positive birefringence layer are disposed at relative positions approximately parallel to each other. It is preferable that the in-plane slow axis of the positive birefringence layer and the in-plane slow axis of the liquid crystal of the liquid crystal cell under application of no voltage are disposed at relative positions approximately perpendicular to each other, and the negative birefringence layer is disposed at a position closer to the liquid cell than the positive birefringence layer. Due to the above relative positions of the negative birefringence layer, the positive birefringence layer, the liquid crystal cell and the two polarizing elements, the minimum value of the contrast can be made 30 or greater at polar angles of 0 to 80°.

In arrangement II-1, the preferable combination of the in-plane retardation Re(A) (the unit: nm) and the retardation in the direction of the thickness Rth(A) (the unit: nm) of the negative birefringence layer and the in-plane retardation Re(B) (the unit: nm) and the retardation in the direction of the thickness Rth(B) (the unit: nm) of the positive birefringence layer is: 10≦Re(A)≦1,000, −500≦Rth(A)≦−5, 10≦Re(B)≦1,000 and 5≦Rth(B)≦500. The more preferable combinations are: (1) 150≦Re(A)≦470, −235≦Rth(A)≦−75, 20≦Re(B)≦480 and 10≦Rth(B)≦240; and (2) 640≦Re(A)≦760, −380≦Rth(A)≦−320, 370≦Re(B)≦470 and 185≦Rth(B)≦235. The still more preferable combination is: 320≦Re(A)≦400, −200≦Rth(A)≦−160, 50≦Re(B)≦170 and 25≦Rth(B)≦85. The most preferable combination is: 340≦Re(A)≦380, −200≦Rth(A)≦−160, 90≦Re(B)≦130 and 35≦Rth(B)≦75.

### (II-2) The Fourth Embodiment of the Preferable Arrangement

FIG. 4 shows a diagram exhibiting the fourth embodiment of the preferable arrangement (referred to as arrangement II-2, hereinafter) of the liquid crystal display device of the present invention. In arrangement II-2, the absorption axis of the polarizing element at the output side and the in-plane slow axis of the liquid crystal of the liquid crystal cell under application of no voltage are disposed at relative positions parallel to each other, and the absorption axis of the polarizing element at the output side and the in-plane slow axis of the liquid crystal of the liquid crystal cell under application of no voltage are disposed at relative positions parallel to each other. The in-plane slow axes of the negative birefringence layer and the positive birefringence layer are disposed at relative positions approximately parallel to each other. It is preferable that the in-plane slow axis of the positive birefringence layer and the in-plane slow axis of the liquid crystal of the liquid crystal cell under application of no voltage are disposed at relative positions approximately parallel to each other, and the positive birefringence layer is disposed at a position closer to the liquid cell than the negative birefringence layer. Due to the above relative positions of the negative birefringence layer, the positive birefringence layer, the liquid crystal cell and the two polarizing elements, the minimum value of the contrast can be made 20 or greater at polar angles of 0 to 80°.

In arrangement II-2, the preferable combination of the in-plane retardation Re(A) (the unit: nm) and the retardation in the direction of the thickness Rth(A) (the unit: nm) of the negative birefringence layer and the in-plane retardation Re(B) (the unit: nm) and the retardation in the direction of the thickness Rth(B) (the unit: nm) of the positive birefringence layer is: 10≦Re(A)≦−1,000, −500≦Rth(A)≦−5, 100≦Re(B)≦450 and 50≦Rth(B)≦225. The most preferable combination is: 420≦Re(A)≦460, −240≦Rth(A)≦−200, 170≦Re(B)≦210 and 75≦Rth(B)≦115.

In the fifth and sixth embodiments of the preferable arrangement, one of the negative birefringence layer and the positive birefringence layer is disposed between the polarizing element at the incident side and the liquid crystal cell and the other is disposed between the polarizing element at the output side and the liquid crystal cell.

### (III-1) The Fifth Embodiment of the Preferable Arrangement

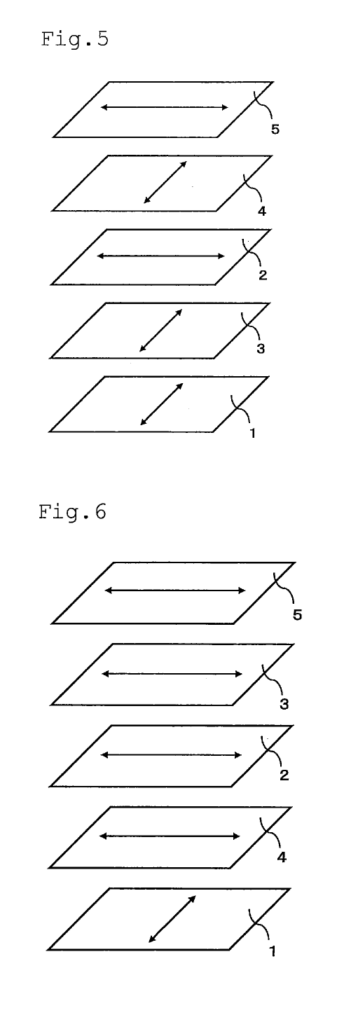

FIG. 5 shows a diagram exhibiting the fifth embodiment of the preferable arrangement (referred to as arrangement III-1, hereinafter) of the liquid crystal display device of the present invention. In arrangement III-1, the absorption axis of the polarizing element at the output side and the in-plane slow axis of the liquid crystal of the liquid crystal cell under application of no voltage are disposed at relative positions parallel to each other. The in-plane slow axes of the negative birefringence layer and the positive birefringence layer are disposed at relative positions approximately parallel to each other. It is preferable that the in-plane slow axis of the negative birefringence layer and the in-plane slow axis of the liquid crystal of the liquid crystal cell under application of no voltage are disposed at relative positions approximately perpendicular to each other, the negative birefringence layer is disposed between the liquid crystal cell and the polarizing element at the incident side, and the positive birefringence layer is disposed between the liquid crystal cell and the polarizing element at the output side. Due to the above relative positions of the negative birefringence layer, the positive birefringence layer, the liquid crystal cell and the two polarizing elements, the minimum value of the contrast can be made 30 or greater at polar angles of 0 to 80°.

In arrangement III-1, the preferable combination of the in-plane retardation Re(A) (the unit: nm) and the retardation in the direction of the thickness Rth(A) (the unit: nm) of the negative birefringence layer and the in-plane retardation Re(B) (the unit: nm) and the retardation in the direction of the thickness Rth(B) (the unit: nm) of the positive birefringence layer is: 10≦Re(A)≦720, −360≦Rth(A)≦−5, 10≦Re(B)≦1,000 and −500≦Rth(B)≦−5. The more preferable combinations are: (1) 170≦Re(A)≦230, −115≦Rth(A)≦−85, 400≦Re(B)≦460 and 200≦Rth(B)≦230; and (2) 270≦Re(A)≦440, −220≦Rth(A)≦−135, 20≦R(B)≦190 and 10≦Rth(B)≦95. The still more preferable combination is: 310≦Re(B)≦410, −205≦Rth(A)≦−155, 50≦Re(B)≦140 and 25≦Rth(B)≦70. The most preferable combination is: 340≦Re(A)≦380, −200≦Rth(B)≦−160, 70≦Re(B)≦110 and 25≦Rth(B)≦65.

### (III-2) The Sixth Embodiment of the Preferable Arrangement

FIG. 6 shows a diagram exhibiting the sixth embodiment of the preferable arrangement (referred to as arrangement III-2, hereinafter) of the liquid crystal display device of the present invention. In arrangement III-2, the absorption axis of the polarizing element at the output side and the in-plane slow axis of the liquid crystal of the liquid crystal cell under application of no voltage are disposed at relative positions parallel to each other. The in-plane slow axes of the negative birefringence layer and the positive birefringence layer are disposed at relative positions approximately parallel to each other. It is preferable that the in-plane slow axis of the negative birefringence layer and the in-plane slow axis of the liquid crystal of the liquid crystal cell under application of no voltage are disposed at relative positions approximately parallel to each other, the positive birefringence layer is disposed between the liquid crystal cell and the polarizing element at the incident side, and the negative birefringence layer is disposed between the liquid crystal cell and the polarizing element at the output side. Due to the above relative positions of the negative birefringence layer, the positive birefringence layer, the liquid crystal cell and the two polarizing elements, the minimum value of the contrast can be made 20 or greater at polar angles of 0 to 80°.

In arrangement III-1, the preferable combination of the in-plane retardation Re(A) (the unit: nm) and the retardation in the direction of the thickness Rth(A) (the unit: nm) of the negative birefringence layer and the in-plane retardation Re(B) (the unit: nm) and the retardation in the direction of the thickness Rth(B) (the unit: nm) of the positive birefringence layer is: 10≦Re(A)≦1,000, −500≦Rth(A)≦−5, 120≦Re(B)≦440 and 60≦Rth(B)≦220. The most preferable combination is: 40≦Re(A)≦80, −50≦Rth(A)≦−10, 340≦Re(B)≦380 and 160≦Rth(B)≦200.

### [Other Panels]

In addition to the above-mentioned IPS and TN modes, other panel display modes of the liquid crystal display device of the invention include OCB (optically compensatory bend), ECB (electrically controlled birefringence), VA (vertical alignment), MVA (multidomain vertical alignment) modes. The film of the invention is also favorably used in reflection-type liquid crystal display devices equipped with a reflection display mode liquid crystal panel.

In the liquid crystal display device of the present invention, suitable layers such as prism array sheets, lens array sheets, light diffusion plates, back lights and films for increasing luminance may be disposed at suitable positions as one or more layers.

### EXAMPLES

The invention is described more concretely with reference to the following Examples, in which the material, the reagent and the substance used, their amount and ratio, and the details of the treatment may be suitably modified or changed not overstepping the sprit and the scope of the invention. Accordingly, the invention should not be limited to the Examples mentioned below.

### <<Measuring Methods>>

### (1) Re[0°], γ, Rth

These optical properties of the film were measured.

### (2) Alignment Angle of Tilt Structure:

The cross section cut in the thickness direction of the film produced according to the method mentioned above was polished and observed with a polarizing microscope (Nikon's Eclipse E600POL), and the alignment angle was determined from the detected extinction position. The polarizer was rotated at intervals of 1° within a range of from −90° to 90°, and the microscopic pictures were divided into 20 sections in the thickness direction of the film, and sequentially separated into layers from the surface of the sample film section on the touch roll side. Of the extinction positions in the thickness direction, the extinction position of the outermost layer on the touch roll side and the extinction position of the outermost layer on the chill roll side were taken. These are the alignment angle of the tilt structure of the touch roll contact surface and the alignment angle of the tilt structure of the chill roll contact surface, respectively.

### (3) Temperature Difference Between Die Lip Heater and Die:

The temperature of the die lip heater (arranged in a length of 1 cm throughout the entire width of the die) arranged at the die outlet port was controlled on the basis of the predetermined temperature of the die outlet port. The difference between the predetermined temperatures is the temperature difference between the die lip heater and the die.

### (4) Interlayer Temperature Difference of Melt:

In two-layer co-extrusion, the melt of 2 cm from the die tip was equally divided into 10 sections over the entire width; and at each section, the melt temperature from the touch roll side was measured with a non-contact thermometer. The found data of those 10 sections were averaged. Next, the melt temperature was measured in the same manner from the chill roll side, or that is, on the opposite (back) side; and the found data of the 10 sections were averaged. The temperature difference between the two is the temperature difference of the melt running out from the extruder (die outlet port).

In three-layer or more multi-layer co-extrusion, the temperature of all the constitutive melt layers was measured, using Thermo Vision, from the side end of the melt in the center part between the die outlet part and the chill roll; and the temperature difference between the adjacent layers was read. Of the found data, the maximum value was taken as the temperature difference of melt. Both side ends of one film sample were analyzed in that manner, and the found data were averaged. The resulting average is the temperature difference of melt.

### (5) Interlayer Viscosity Difference of Melt:

Like in the method of measuring the interlayer temperature difference of melt as above, the melt temperature of each layer (for example, layer i) was measured, and this is the test temperature condition Ti in the viscoelastometer. Separately, the resin used as the starting material for the layer (layer i) was fully dried to have a water content of at most 0.1%, and this is a resin sample for viscosity measurement. Using a viscoelastometer equipped with parallel cones (e.g., Anton Paar's Modular Compact Rheometer, Physica MCR301), the melt viscosity of the resin sample was measured. The test condition was as follows: The gap was 500 μm, the frequency was 1 Hz, the strain was 1%, and the temperature was Ti ° C. This is the melt viscosity (ηi) of the melt of the layer (layer i).

The other layers were analyzed in the same manner as above. Briefly, the melt temperature was measured for determining the test temperature condition in the viscoelastometer; and the melt viscosity of the resin used as the starting material for each layer was measured with a viscoelastometer.

From the found data of the melt viscosity, the interlayer viscosity difference of melt was computed.

Of all the data of the melt viscosity difference between the adjacent layers, the highest value is the melt viscosity difference of the analyzed sample.

### [Resin]

### (1) Positive Birefringent Resin

COP (Norbornene Resin of Ring-Opening Polymerization Type)

P-1: Pellet of ZEONOR1020 (manufactured by Zeon Corporation, Tg 105° C.)
P-2: Pellet of ZEONOR1420R (manufactured by Zeon Corporation, Tg 136° C.)
P-3: Pellet of ZEONOR1600R (manufactured by Zeon Corporation, Tg 163° C.)

COC (Norbornene Resin of Addition Polymerization Type)

P-4: Pellet of TOPAS 6013 (manufactured by Polyplastics, Tg 130° C.)

PC

P-5: Pellet of Toughlon MD1500 (manufactured by Idemitsu, Tg 142° C.)

Cellulose Acylate Resin

P-6: Cellulose acetate propionate (CAP-1) was prepared in accordance with the method described in Example 1 of JP-A 2008-87398 and this was pelletized in an ordinary manner. Regarding its composition, CAP-1 has a degree of acetylation of 1.95, a degree of propionylation of 0.70, a total degree of acyl substitution of 2.65, and a glass transition point of the resin is 174° C.
P-7: Cellulose acetate propionate (CAP-2) was prepared in accordance with the method of Example 101 described in Table 3 of JP-A 2008-50562 and this was pelletized in an ordinary manner. Regarding its composition, CAP-2 has a degree of acetylation of 0.15, a degree of propionylation of 2.55, a total degree of acyl substitution of 2.70, and a glass transition point of the resin is 137° C.

### (2) Negative Birefringent Resin

Acrylic Resin

N-1: Acrylic resin was prepared from 7500 g of methyl methacrylate and 2500 g of methyl 2-(hydroxymethyl)acrylate in accordance with Production Example 1 described in [0222] to of JP-A 2008-9378. The produced acrylic resin has a lactone conversion of 98% and a glass transition point of 134° C.

Styrene Resin

N-2: Styrene/maleic anhydride copolymer (Tg 130° C., as disclosed in Production Example 1 of WO 2005/050299)
N-3: Styrene/maleic anhydride copolymer (manufactured by Nova Chemical Japan, Dylark D332, Tg−30° C.)

### (3) Adhesive

A-1: Modified ethylene/vinyl acetate copolymer (Tg 80° C., as disclosed in Production Example 1 of WO 2005/050299)

### [Co-Extruded Multi-Layer Film (Negative Birefringence Film) Production]

Each polymer pellets were selected as shown in Table 1 and were dried at (Tg−10)° C. for at least 2 hours, then acryl-based polymers were melted at 230° C. and the others were melted at 260° C., and kneaded and extruded using a single-screw kneading extruder. A screen filter, a gear pump and a leaf disc filter were disposed in that order between the extruder and a die, and these were connected to each other via a melt pipe. The resin melt was extruded out at the extrusion temperature (melt temperature) shown in Table 1, through the die having a width of 450 mm and a lip gap of 1 mm. The extrusion temperature was varied as in Table 1 and the resins were also varied thereby attaining the melt viscosity difference as in Table 1. In Examples 1 to 21 of the invention and in Comparative Example 1, the above-mentioned adhesive A-1 was arranged in a thickness of 2 μm between the first layer and the second layer and between the second layer and the third layer; and in Examples 22 to 50 of the invention and in Comparative Examples 9 and 10, the above-mentioned adhesive A-2 was arranged between the first layer and the second layer and between the second layer and the third layer in such a manner that the thickness of the adhesive layer after lamination could be 3 μm each. In these, the resins and the adhesive were co-extruded simultaneously.

Further, a die lip heater was arranged at the die outlet port (to a length of 1 cm throughout the overall width of the die); and its temperature was set higher or lower than the die temperature to thereby control the temperature of the outermost layer of the resin melt. In that manner, the temperature control was attained based on the melt temperature and the die lip heater.

Then, the resin melt was led through extrusion into the center part nip-pressed by a casting roll (at Tg−10° C.) and a chill roll (at Tg−5° C.). Then, melt casting and nip-pressing was performed under the conditions described in Table 1. In this process, the HCr-plated metallic touch roll (TR) having a width of 1500 mm, a diameter of 600 mm and a thickness of 10 mm and the HCr-plated metallic casting roll (chill roll or CR) having a width of 1800 mm, a diameter of 400 mm and a thickness of 30 mm were used. The temperature of the TR was controlled 10° C. lower than Tg of the resin which kept in contact with TR, and the temperature of the CR was controlled 5° C. lower than Tg of the melted resin which kept in contact with CR. The temperature of the TR and the CR was controlled by passing a temperature controlled heat medium through thereof. The thickness of the melted resin was so controlled that the thickness of each film was 40 μm after the stretching. The touch pressure was measured by putting a prescale (by FUJIFILM Corporation) between the two rolls under no melt, and the found value was taken as the pressure to be given to the melt in film formation. In pressure measurement, the roll temperature was 25° C. and the roll speed was 5 m/min for both rolls. The touch roll and the chill roll had the Shore hardness 60. Using these rolls, the touch roll peripheral speed, the chill roll peripheral speed and the difference of peripheral speed were varied as in Table 1, and under the condition, films were produced.

The distance between the die and the melt landing point was 50 mm. The atmosphere in film formation was at 25° C. and relative humidity 60%.

Next, just before winding, the film was trimmed on both sides (each 5 cm of the overall width), and knurled on both sides to a width of 10 mm and a height of 20 μm. Having a width of 1250 mm, the formed film was wound up at a machine speed of 25 m/min (chill roll speed) to a length of 3000 m. Thus Example and Comparative Example films were formed.

### [Evaluation]

In the thus-formed film, the angle to the film normal line of the tilt structure was measured according to the above-mentioned method. According to the method described herein, γ, Re[0°] and Rth of the film were measured. Further, according to the method mentioned below, the temporal stability of Re and the curling degree of the film were measured.

### <Temporal Stability of Re>

The stretched film was sampled at regular intervals in 10 points in the transverse direction, and analyzed for Re[0°] at 25° C. and 60% RH according to the above-mentioned method. This is Re[0°]s.

The sample was thermo-treated at (Tg−20)° C. for 20 hours, and its Re[0°] was measured according to the above-mentioned method. This is Re[0°]t.

At each 10 points in the transverse direction, the Re fluctuation (%) was determined according to the formula mentioned below, and the average of the data indicates the temporal stability of Re.

Temporal Stability of Re(%)=100×(Re[0°]s−Re[0°]t)/Re[0°]s.

The temporal stability of Re is preferably at most 5%, more preferably at most 4%, even more preferably at most 3%.

### <Curling>

The sample film was blanked into a piece having a size of 3 mm×35 mm in MD×TD. The sample having the 35-mm side in MD is called “MD sample” and that having the 35-mm side in TD is “TD sample”.

At the point equally divided into 10 sections in the width of the film, one MD sample and one TD sample were cut out.

The MD sample and the TD sample were individually set on a curling plate described in “ANSI/ASCPH1.29-1985”, and left thereon at 80° C. for 5 hours, and the curling value (the inverse of the radius of curvature (expressed as “m”), m⁻¹) was measured.

Of the average value of the found data of 10 points of the MD sample and that of the found data of 10 points of the TD sample, the larger one is shown as the curling value in Table 1.

The curling value is preferably at most 10 m⁻¹, more preferably at most 8 m⁻¹, even more preferably at most 6 m⁻¹.

### [Production of Liquid Crystal Display Device]

### (1) Production of Positive Birefringent Film:

The above resin P-2 was extruded out at 260° C., then cooled and solidified for film formation on a chill roll at 130° C. according to a static charging method. The film was uniaxially stretched in the transverse direction at a temperature of 140° C., at a draw ratio of 1.3 times and at a drawing speed of 92%/min, using a tenter, thereby giving a positive birefringent film having a slow axis in the transverse direction of the film and having a width of 1.5 m and a thickness of 60 μm. The in-plane retardation Re of the film was 60 nm, and the thickness-direction retardation Rth thereof was 60 nm. This is B1.

The positive birefringent film (B-1) and a polarizer (manufactured by SANRITZ Company; HLC2-5618) were laminated in accordance with the roll-to-roll process to obtain an optical element (B′1). The angle between the slow axis of the positive birefringent film (B-1) and the absorption axis of the optical element (B′1) was 900.

Optical element (a′1) was obtained by laminating the co-extruded film and the optical film (B′1) in accordance with the roll-to-roll process. The angle between the slow axis of the co-extruded film and the absorption axis of the optical element (b′1) obtained above was 90°. A plate obtained by cutting out of optical element (a′1) obtained above was used as polarizer of the incident side (A′1).

### (3) Preparation of a Hard Coating Polarize

### (3-1) Preparation of a Hard Coating Agent

To 100 parts by weight of a modified alcohol sol of antimony pentaoxide [the concentration of solid components: 30% by weight; manufactured by SHOKUBAI KASEI Co., Ltd.], 10 parts by weight of a urethane acrylate of the ultraviolet light curing type [the trade name: SHIKO UV7000B; manufactured by NIPPON GOSEI KAGAKU Co., Ltd.] and 0.4 parts by weight of a photopolymerization initiator [the trade name: IRGACURE 184; manufactured by CIBA GEIGY Company] were mixed, and a hard coating agent of the ultraviolet light curing type was obtained.

### (3-2) Preparation of a Coating Fluid for a Low Refractive Index Layer

To 208 parts by weight of tetraethoxysilane, 356 parts by weight of methanol was added. Then, 18 parts by weight of water and 18 parts by weight of 0.01N hydrochloric acid were mixed with the resultant solution, and the obtained mixture was mixed well by a disper. The mixed solution was stirred for 2 hours in a vessel kept at 25° C., and a tetrafunctional silicone resin having a weight-average molecular weight of 850 was obtained. To the tetrafunctional silicone resin, a dispersion sol of hollow silica in isopropanol (IPA) [the content of solid components: 20% by mass; the average diameter of primary particles: 35 nm: the thickness of the outer shell: about 8 nm; manufactured by SHOKUBAI KASEI KOGYO Co., Ltd.] as the component of fine particles of hollow silica was added in an amount such that the ratio of the amounts by mass of solid components in the hollow silica fine particles to those in the tetrafunctional silicone resin (calculated as condensed compounds) was 85/25. The resultant mixture was diluted with methanol so that the content of the entire solid components was 10% by mass, and a coating fluid for a low refractive index layer was obtained.

### (3-3) Preparation of a Hard Coat Layer

One face of a long sheet of a polarizer [manufactured by SANRITZ Company; HLC2-5618S] was treated by corona discharge for 3 seconds using a high frequency oscillator [CORONA GENERATOR HV05-2; manufactured by TAMTEC Company], and the surface was modified so that the surface tension was 0.072 N/m. The surface modified above was continuously coated with the hard coating agent obtained in Preparation Example I using a die coater in a manner such that the thickness of the hard coat layer obtained after being cured was 5 μm After the coating layer was dried at 80° C. for 5 minutes, the coating layer was irradiated with ultraviolet light (the accumulated amount of light: 300 mJ/cm²) to cure the hard coating agent, and a long sheet of polarizer (C′) laminated with the hard coat layer was obtained. The hard coat layer had a thickness of 5 μm, a refractive index of 1.62 and a surface roughness of 0.2 μm after being cured.

### (3-4) Preparation of Low Refractive Index Layer

The long sheet of polarizer (C′) laminated with the hard coat layer was coated with the coating fluid for a low refractive index layer obtained in Preparation Example II as the material constituting the low refractive index layer using a wire bar coater. After the heat treatment in the air at 120° C. for 5 minutes, a long sheet of polarizer (C) laminated with the low refractive index layer and the hard coat layer in which the low refractive index layer had a thickness of 100 nm was obtained. The refractive index of the obtained low refractive index layer was 1.34.

### (4) Application of the Polarizer to a Liquid Crystal Display Device

### (4-1) Liquid Crystal Display Device of IPS Mode

A polarizer at the incident side in a commercial liquid crystal display device of the in-plane switching (IPS) mode was replaced with polarizer of the incident side (A′1). The polarizer at the output side in the liquid crystal display device was replaced with a plate obtained by cutting out of the long sheet of polarizer (C) laminated with the low refractive index layer and the hard coat layer which was obtained in (3-4) above. The members of the liquid crystal display device were arranged in a manner such that the absorption axis of polarizer of the output side and the in-plane slow axis of the liquid crystal cell under application of no voltage were parallel to each other, and the absorption axis of polarizer of the incident side (A′1) and the in-plane slow axis of the liquid crystal cell under application of no voltage were perpendicular to each other, and a liquid crystal display device having the structure shown in FIG. 1, LCD-1, was prepared. The obtained device had a structure in which the members were disposed in the following order from the side of vision of the liquid crystal display device: the low refractive index layer, the hard coat layer, the polarizer, the liquid crystal cell, the co-extruded film, the positive birefringent film, and the polarizer.

### (4-2) TN-Mode Liquid Crystal Display Device:

The pair of polarizers set were peeled off from a liquid crystal display device having a TN-mode liquid crystal cell (AQUOS LC-20C1-S, by Sharp), and in place of them, the polarizers produced according to the above-mentioned production methods of “positive birefringent film”, “polarizer” and “hard coat-having polarizer” were set in the device in such a manner that the film of the invention produced in Example could face the liquid crystal cell via an adhesive. Each one polarizer was stuck to the device on the viewers' side and on the backlight side. However, before stuck, the film of example was forcedly aged (at (Tg−20)° C. for 20 hours). This means that the test method is equal to display evaluation after long-term use for a few years.

The entire panel was kept for white level expression, and the panel was evaluated from the frequency (from 0 to 10 points) of color shift as detected in observation in the upper oblique direction at 50°. The point “10” means that the panel entire surface had color shift; and the point “0” means that the panel had no color shift.

### (4) Evaluation of Liquid Crystal Display Device:

The obtained liquid crystal display device LCD-1 was kept for black expression in the entire panel, and put in a dark room. In that condition, this was watched in the front direction with the naked eye, and at an oblique angle of 60° (as measured from the normal line direction of the LCD panel). The color shift between the two was evaluated in 10 ranks of from 0 to 10 points, and the results are shown in Table 1. In this, the point “10” means the largest color shift; and the point “0” means the smallest color shift. The acceptable level is at most the point “7”.

TABLE 1

| | | | | | | | | | Temperature | | | | | |
|---|---|---|---|---|---|---|---|---|---|---|---|---|---|---|
| | | | | | | | | | Difference | | Interlayer | | | |
| | | | | | | | Temperature | | between Die | | Viscosity | | Interlayer | |
| | | | | | | | Difference of Melt | | Lip Heater | | Difference of | | Temperature | |
| | Resin for Co-extrusion | | | Thickness of | | | in Extruder | | and Die | | Melt | | Difference | |
| | 1st | | | Layer after | | | | 3rd | 2nd | 3rd | 2nd | 3rd | of Melt | |
| | layer | | 3rd | Film Formation | | | 2nd | layer − | layer − | layer − | layer − | layer − | 2nd | 3rd |
| | (touch | | layer | 1st | 2nd | 3rd | layer − | 2nd | 1st | 2nd | 1st | 2nd | layer − | layer − |
| | roll | 2nd | (chill roll | layer | layer | layer | 1st layer | layer | layer | layer | layer | layer | 1st layer | 2nd layer |
| | side) | layer | side) | μm | μm | μm | ° C. | ° C. | ° C. | ° C. | Pa · s | Pa · s | ° C. | ° C. |
| Comparative | P-1 | N-2 | P-1 | 8 | 16 | 8 | 0 | 0 | — | — | 0 | 0 | 0 | 0 |
| Example 1 | | | | | | | | | | | | | | |
| Example 1 | P-1 | N-2 | P-1 | 8 | 16 | 8 | 0 | 0 | — | — | 0 | 0 | 0 | 0 |
| Example 2 | P-1 | N-2 | P-1 | 8 | 16 | 8 | 0 | 0 | — | — | 0 | 0 | 0 | 0 |
| Example 3 | P-1 | N-2 | P-1 | 8 | 16 | 8 | 0 | 0 | — | — | 0 | 0 | 0 | 0 |
| Example 4 | P-1 | N-2 | P-1 | 8 | 16 | 8 | 0 | 0 | — | — | 0 | 0 | 0 | 0 |
| Example 5 | P-1 | N-2 | P-1 | 8 | 16 | 8 | 0 | 0 | — | — | 0 | 0 | 0 | 0 |
| Example 6 | P-1 | N-2 | P-1 | 8 | 16 | 8 | 0 | 0 | — | — | 0 | 0 | 0 | 0 |
| Example 7 | P-1 | N-2 | P-1 | 8 | 16 | 8 | 0 | 0 | — | — | 0 | 0 | 0 | 0 |
| Example 8 | P-1 | N-2 | P-1 | 8 | 16 | 8 | 0 | 0 | — | — | 0 | 0 | 0 | 0 |
| Example 9 | P-1 | N-2 | P-1 | 8 | 16 | 8 | 0 | 0 | — | — | 0 | 0 | 0 | 0 |
| Example 10 | P-1 | N-2 | P-1 | 8 | 16 | 8 | 0 | 0 | — | — | 0 | 0 | 0 | 0 |
| Example 11 | P-1 | N-2 | P-1 | 8 | 16 | 8 | 0 | 0 | — | — | 0 | 0 | 0 | 0 |
| Example 12 | P-1 | N-2 | P-1 | 8 | 16 | 8 | 0 | 0 | — | — | 0 | 0 | 0 | 0 |
| Example 13 | P-1 | N-2 | P-1 | 8 | 16 | 8 | 0 | 0 | — | — | 0 | 0 | 0 | 0 |
| Example 14 | P-1 | N-2 | P-1 | 8 | 16 | 8 | 8 | 8 | 3 | 3 | 120 | 120 | 11 | 11 |
| Example 15 | P-1 | N-2 | P-1 | 8 | 16 | 8 | 0 | 0 | — | — | 0 | 0 | 0 | 0 |
| Example 16 | P-1 | N-2 | P-1 | 8 | 16 | 8 | 1 | 1 | — | — | 12 | 12 | 1 | 1 |
| Example 17 | P-1 | N-2 | P-1 | 8 | 16 | 8 | 3 | 3 | — | — | 19 | 19 | 3 | 3 |
| Example 18 | P-1 | N-2 | P-1 | 8 | 16 | 8 | 10 | 10 | — | — | 100 | 100 | 10 | 10 |
| Example 19 | P-1 | N-2 | P-1 | 8 | 16 | 8 | 26 | 26 | — | — | 350 | 350 | 26 | 26 |
| Example 20 | P-1 | N-2 | P-1 | 8 | 16 | 8 | 30 | 30 | — | — | 500 | 500 | 29 | 29 |
| Example 21 | P-1 | N-2 | P-1 | 8 | 16 | 8 | 32 | 32 | — | — | 510 | 510 | 31 | 31 |
| Example 22 | P-4 | N-1 | P-4 | 20 | 40 | 20 | 0 | 0 | 0 | 0 | 0 | 0 | 0 | 0 |
| Example 23 | P-4 | N-1 | P-4 | 20 | 40 | 20 | 0 | 0 | 0 | 2 | 0 | 11 | 0 | 2 |
| Example 24 | P-4 | N-1 | P-4 | 20 | 40 | 20 | 0 | 0 | 2 | 2 | 11 | 11 | 2 | 2 |
| Example 25 | P-4 | N-1 | P-4 | 20 | 40 | 20 | 0 | 0 | 12 | 12 | 130 | 130 | 12 | 12 |
| Example 26 | P-4 | N-1 | P-4 | 20 | 40 | 20 | 0 | 0 | 28 | 28 | 490 | 490 | 27 | 27 |
| Example 27 | P-4 | N-1 | P-4 | 20 | 40 | 20 | 0 | 0 | 32 | 32 | 505 | 505 | 31 | 31 |
| Example 28 | P-1 | N-2 | P-1 | 15 | 100 | 15 | 0 | 0 | 0 | 0 | 0 | 0 | 0 | 0 |
| Example 29 | P-2 | N-2 | P-1 | 15 | 100 | 15 | 0 | 0 | 0 | 0 | 200 | 0 | 0 | 0 |
| Example 30 | P-3 | N-2 | P-1 | 15 | 100 | 15 | 0 | 0 | 0 | 0 | 400 | 0 | 0 | 0 |
| Example 31 | P-3 | N-2 | P-1 | 15 | 100 | 15 | 0 | 5 | 0 | 0 | 400 | 80 | 0 | 5 |
| Example 32 | P-3 | N-2 | P-1 | 15 | 100 | 15 | 0 | 5 | 0 | 5 | 400 | 140 | 0 | 8 |
| Example 34 | P-3 | N-2 | P-1 | 2 | 100 | 2 | 0 | 5 | 0 | 5 | 400 | 140 | 0 | 8 |
| Example 35 | P-3 | N-2 | P-1 | 4 | 100 | 4 | 0 | 5 | 0 | 5 | 400 | 140 | 0 | 8 |
| Example 36 | P-3 | N-2 | P-1 | 20 | 100 | 20 | 0 | 5 | 0 | 5 | 400 | 140 | 0 | 8 |
| Example 37 | P-3 | N-2 | P-1 | 90 | 100 | 90 | 0 | 5 | 0 | 5 | 400 | 140 | 0 | 8 |
| Example 39 | P-5 | N-3 | P-5 | 5 | 20 | 5 | 15 | 15 | 7 | 7 | 220 | 220 | 21 | 21 |
| Example 40 | P-5 | N-3 | P-7 | 5 | 25 | 15 | 7 | 20 | 5 | 8 | 120 | 220 | 11 | 27 |
| Example 41 | P-6 | N-2 | P-6 | 15 | 30 | 15 | 10 | 10 | 5 | 5 | 160 | 160 | 15 | 15 |
| Example 42 | P-1 | N-1 | — | 20 | 40 | — | −22 | — | −5 | — | −220 | — | −26 | — |
| Comparative | P-1 | — | — | 32 | — | — | — | — | — | — | — | — | — | — |
| Example 4 | | | | | | | | | | | | | | |
| Comparative | P-5 | — | — | 107 | — | — | — | — | — | — | — | — | — | — |
| Example 5 | | | | | | | | | | | | | | |
| Example 43 | P-5 | P-5 | — | 53.5 | 53.5 | — | 5 | — | 3 | — | 30 | — | 7 | — |
| Example 44 | P-5 | N-2 | — | 53.5 | 53.5 | — | 5 | — | 3 | — | 120 | — | 7 | — |
| Comparative | P-1 | — | — | 107 | — | — | — | — | — | — | — | — | 13 | — |
| Example 6 | | | | | | | | | | | | | | |
| Comparative | P-1 | — | — | 107 | — | — | — | — | — | — | — | — | — | — |
| Example 7 | | | | | | | | | | | | | | |
| Comparative | P-1 | — | — | 107 | — | — | — | — | — | — | — | — | — | — |
| Example 8 | | | | | | | | | | | | | | |
| Comparative | P-1 | N-2 | — | 53.5 | 53.5 | — | 5 | — | 3 | — | 120 | — | 7 | — |
| Example 9 | | | | | | | | | | | | | | |
| Example 45 | P-1 | N-2 | — | 53.5 | 53.5 | — | 5 | — | 3 | — | 120 | — | 7 | — |
| Example 46 | P-1 | N-2 | — | 53.5 | 53.5 | — | 5 | — | 3 | — | 120 | — | 7 | — |
| Example 47 | P-1 | N-2 | P-1 | 35 | 37 | 35 | 5 | 5 | 3 | 3 | 120 | 120 | 7 | 7 |
| Comparative | P-1 | P-5 | — | 53.5 | 53.5 | — | 5 | — | 3 | — | 30 | — | 7 | — |
| Example 10 | | | | | | | | | | | | | | |
| Example 48 | P-1 | P-5 | — | 53.5 | 53.5 | — | 5 | — | 3 | — | 30 | — | 7 | — |
| Example 49 | P-1 | P-5 | — | 53.5 | 53.5 | — | 5 | — | 3 | — | 30 | — | 7 | — |
| Example 50 | P-1 | P-5 | P-1 | 35 | 37 | 35 | 5 | 5 | 3 | 3 | 30 | 30 | 7 | 7 |

| | | | Physical Properties of Co-extruded Film | | | | | | | | |
|---|---|---|---|---|---|---|---|---|---|---|---|
| | Touch Film | | alignment angle of | | | | | | | Properties of | |
| | Formation | | tilt structure | | | | | | | Liquid crystal | |
| | | touch roll | touch roll | chill roll | | | | | | Display Panel | |
| | touch | peripheral | contact | contact | | | | temporal | | color | color |
| | pressure | speed di- | surface | surface | γ | Re[0°] | Rth | stability | curling | shift in | shift in |
| | MPa | fference % | °(degree) | °(degree) | nm | nm | nm | of Re % | m⁻¹ | IPS | TN |
| Comparative | — | — | 88 | 88 | 0 | 2 | 4 | 8 | 15 | 10 | 10 |
| Example 1 | | | | | | | | | | | |
| Example 1 | 30 | 0 | 87 | −87 | 10 | 55 | −30 | 5 | 10 | 7 | 7 |
| Example 2 | 35 | 0 | 85 | −85 | 15 | 75 | −35 | 3 | 6 | 4 | 4 |
| Example 3 | 100 | 0 | 60 | −61 | 18 | 90 | −40 | 3 | 5 | 4 | 4 |
| Example 4 | 250 | 0 | 48 | −47 | 21 | 110 | −55 | 3 | 6 | 5 | 6 |
| Example 5 | 500 | 0 | 40 | −40 | 22 | 280 | −90 | 5 | 9 | 7 | 8 |
| Example 6 | 150 | 0 | 86 | −86 | 42 | 35 | −5 | 5 | 10 | 7 | 8 |
| Example 7 | 150 | 0.5 | 84 | −84 | 55 | 55 | −15 | 3 | 6 | 4 | 3 |
| Example 8 | 150 | 1.5 | 75 | −75 | 75 | 70 | −25 | 1 | 4 | 2 | 1 |
| Example 9 | 150 | 5 | 65 | −65 | 100 | 90 | −45 | 0 | 0 | 0 | 0 |
| Example 10 | 150 | 12.5 | 60 | −59 | 170 | 150 | −60 | 1 | 3 | 2 | 1 |
| Example 11 | 150 | 20 | 52 | −51 | 200 | 180 | −75 | 3 | 5 | 5 | 4 |
| Example 12 | 150 | 22 | 48 | −47 | 250 | 220 | −90 | 5 | 10 | 7 | 7 |
| Example 13 | 100 | 3 | 83 | −84 | 80 | 70 | −35 | 2 | 4 | 4 | 3 |
| Example 14 | 100 | 3 | 65 | −63 | 100 | 90 | −45 | 0 | 0 | 0 | 0 |
| Example 15 | 80 | 4 | 82 | −82 | 60 | 50 | −25 | 5 | 10 | 5 | 6 |
| Example 16 | 80 | 4 | 75 | −74 | 80 | 70 | −35 | 3 | 7 | 3 | 2 |
| Example 17 | 80 | 4 | 72 | −71 | 85 | 75 | −40 | 1 | 2 | 1 | 1 |
| Example 18 | 80 | 4 | 65 | −66 | 110 | 90 | −55 | 0 | 1 | 0 | 0 |
| Example 19 | 80 | 4 | 62 | −63 | 130 | 100 | −60 | 2 | 2 | 1 | 1 |
| Example 20 | 80 | 4 | 70 | −67 | 85 | 70 | −35 | 3 | 6 | 3 | 3 |
| Example 21 | 80 | 4 | 80 | −80 | 65 | 50 | −20 | 5 | 9 | 5 | 6 |
| Example 22 | 120 | 7 | 48 | −49 | 70 | 60 | −30 | 5 | 9 | 5 | 6 |
| Example 23 | 120 | 7 | 49 | −48 | 90 | 75 | −40 | 3 | 6 | 3 | 3 |
| Example 24 | 120 | 7 | 48 | −49 | 100 | 85 | −45 | 0 | 2 | 1 | 1 |
| Example 25 | 120 | 7 | 50 | −50 | 120 | 100 | −50 | 1.5 | 2 | 0 | 0 |
| Example 26 | 120 | 7 | 49 | −49 | 85 | 75 | −40 | 2.5 | 6 | 3 | 2 |
| Example 27 | 120 | 7 | 48 | −49 | 75 | 65 | −30 | 5 | 9 | 5 | 6 |
| Example 28 | 100 | 5 | 62 | −62 | 80 | 70 | −35 | 5 | 9 | 5 | 6 |
| Example 29 | 100 | 5 | 60 | −60 | 140 | 120 | −60 | 0 | 2 | 1 | 1 |
| Example 30 | 100 | 5 | 60 | −62 | 100 | 85 | −40 | 4 | 6 | 4 | 5 |
| Example 31 | 100 | 5 | 60 | −62 | 105 | 95 | −50 | 2 | 3 | 3 | 2 |
| Example 32 | 100 | 5 | 59 | −62 | 120 | 115 | −60 | 0 | 1 | 1 | 0 |
| Example 34 | 100 | 5 | 83 | −83 | 45 | 45 | −10 | 2.5 | 2 | 7 | 6 |
| Example 35 | 100 | 5 | 80 | −79 | 70 | 65 | −20 | 2 | 2 | 2 | 2 |
| Example 36 | 100 | 5 | 65 | −65 | 140 | 95 | −50 | 1 | 2 | 0 | 0 |
| Example 37 | 100 | 5 | 84 | −83 | 65 | 55 | −85 | 1 | 4 | 7 | 6 |
| Example 39 | 180 | 3 | 65 | −70 | 240 | 180 | −30 | 1 | 1 | 3 | 4 |
| Example 40 | 180 | 3 | 62 | −76 | 75 | 60 | −60 | 1 | 3 | 2 | 3 |
| Example 41 | 180 | 3 | 62 | −58 | 90 | 70 | −50 | 2 | 1 | 2 | 2 |
| Example 42 | 180 | 3 | 55 | −57 | 110 | 80 | −40 | 0 | 3 | 3 | 4 |
| Comparative | 80 | 4 | 80 | −78 | 100 | 80 | −10 | 7 | 0 | 10 | 10 |
| Example 4 | | | | | | | | | | | |
| Comparative | * | * | 55 | 55 | 250 | 268 | 200 | 8 | 0 | 10 | 10 |
| Example 5 | | | | | | | | | | | |
| Example 43 | 100 | 5 | 65 | −63 | 260 | 240 | 90 | 4 | 1 | 7 | 6 |
| Example 44 | 100 | 5 | 65 | −64 | 250 | 150 | −20 | 2 | 0 | 0 | 0 |
| Comparative | — | — | 87 | 87 | 10 | 5 | −7 | 9 | 0 | 10 | 10 |
| Example 6 | | | | | | | | | | | |
| Comparative | 100 | 0 | 70 | −70 | 15 | 240 | −130 | 8 | 0 | 10 | 10 |
| Example 7 | | | | | | | | | | | |
| Comparative | 100 | 5 | 65 | −55 | 115 | 220 | −100 | 8 | 0 | 10 | 10 |
| Example 8 | | | | | | | | | | | |
| Comparative | — | — | 88 | 88 | 10 | 10 | −5 | 10 | 12 | 10 | 10 |
| Example 9 | | | | | | | | | | | |
| Example 45 | 100 | 0 | 72 | −70 | 20 | 200 | −110 | 5 | 5 | 5 | 6 |
| Example 46 | 100 | 5 | 60 | −50 | 220 | 210 | −100 | 3 | 3 | 3 | 2 |
| Example 47 | 100 | 5 | 58 | −49 | 170 | 150 | −80 | 1 | 0 | 0 | 0 |
| Comparative | — | — | 88 | 88 | 12 | 12 | 5 | 11 | 12 | 10 | 10 |
| Example 10 | | | | | | | | | | | |
| Example 48 | 100 | 0 | 70 | −70 | 15 | 210 | 100 | 5 | 6 | 8 | 7 |
| Example 49 | 100 | 5 | 60 | −65 | 220 | 190 | 90 | 4 | 3 | 6 | 6 |
| Example 50 | 100 | 5 | 60 | −68 | 240 | 170 | 85 | 2 | 2 | 5 | 5 |

Comparative Examples 1 and Examples 1 to 5 of the invention demonstrate the influence of the touch pressure on the tilt structure. Examples 6 to 12 of the invention demonstrate the influence of the peripheral speed difference between the touch roll and the chill roll on the tilt structure. Examples 13 and 14 of the invention demonstrate the effect of the temperature difference of melt given by the melt and the lip heater. Examples 15 to 21 of the invention demonstrate the effect of the temperature difference and the viscosity difference of melt given by the extruder. Examples 22 to 27 of the invention demonstrate the effect of the temperature difference and the viscosity difference of melt given by the lip heater. Examples 28 to 30 of the invention demonstrate the effect of the viscosity difference of melt given by changing the resin. Examples 30 to 32 of the invention demonstrate the synergistic effect of the effect of the melt temperature difference as combined with the effect of the melt temperature difference by the lip heater sequentially added thereto. Examples 34 to 37 of the invention demonstrate the effect of the varying thickness of the constitutive layers. Examples 39 to 42 of the invention indicate application of the invention to various types of resins; and Comparative Example 4 is an example of a single-layer film.

Comparative Example 5 is a film F-7 of Example 1 in JP-A 6-222213, in which the formed solidified film (not in a melt state) was processed between hot rolls with a peripheral speed difference given thereto thereby to have a monolithic tilt structure formed thereon. On the other hand, in Example 43 of the invention, the same resin as in Comparative Example 5 was used but was formed into a two-layer tilt-structured film by imparting thereto a temperature difference to provide the alignment angle difference in the tilt structure between the surface and the back of the film. Example 44 of the invention is a two-layer tilt-structured film comprising positive and negative birefringent resins. The color shift reduced in the order of Comparative Example 5>Example 43 of the invention>Example 44 of the invention, and the effect of color shift removal in the invention is remarkable

Comparative Examples 6 to 8 are single-layer films. In Comparative Example 6, a touch roll was not used in film formation; in Comparative Example 7, a touch

roll was used but no peripheral speed difference was given thereto; in Comparative Example 8, a touch roll was used and a peripheral speed difference was given thereto. All these comparative films had poor temporal stability of Re and provided much color shift.

In Comparative Example 9 and Examples 45 to 47 of the invention, a positive birefringent layer and a negative birefringent layer were laminated. In Comparative Example 9, no touch roll was used in film formation, and therefore the formed film had poor temporal stability of Re and provided much color shift; but in the film of Example 45 of the invention, the tilt angle expressed an alignment angle, and the temporal stability of Re of the film was bettered and the film was free from the problem of color shift. In Example 46 of the invention in which a peripheral speed difference was given during film formation, the formed film was further bettered in point of the temporal stability of Re and the color shift reduction. The effect was more remarkable in the three-layer positive/negative/positive structure.

In Comparative Example 10 and Examples 48 to 50 of the invention, birefringent layers were laminated; and in these, the films exhibited the same effect as that in the above-mentioned Comparative Example 9 and Examples 45 to 47 of the invention, but their effect was lower than the effect of the latter in which the film had a combination of positive/negative layers.

As in the above, the thermoplastic films of the invention are excellent in the temporal stability of Re and the curling resistance.

In addition, the liquid crystal display devices of the invention have excellent liquid crystal display characteristics (free from color shift).

### (Production of Stretched Film)

The co-extruded film (negative birefringent film) of the invention was stretched according to the method described in Table 2. The stretching temperature was (Tg+1)° C.; and the draw ratio in stretching was as in Table 2 below. The thickness of the thus-stretched film was 40 μm.

### Transverse Stretching Method (T Method in Table 2):

Using an ordinary tenter, the film was stretched in TD (transverse direction). The traveling speed of the right and the left chucks was the same, and the tenter was driven straightly (not bent).

### Oblique Stretching Method 1 (N-1 Method in Table 2):

The film was stretched according to the method of Example 2 in JP-A 2008-221834, in which the traveling speed was made different between the right and the left chucks, and the alignment angle was thereby varied. Toward the traveling direction, the left-side chuck speed is represented by VL, and the right-side chuck speed is by VR. The speed difference (%) between the two is 100×|VR−VL|/{(VR+VL)/2}, and is shown in Table 2. When stretched with the speed difference of 10% given to the film, the alignment angle was 45°.

### Oblique Stretching Method 2 (N-2 Method in Table 2):

According to Example 1 in WO2003/102639, the former half and the latter half of the tenter was dogleg-bent. The dogleg angle was varied to thereby vary the alignment angle in the stretched film.

### <Mean Alignment Angle of Slow Axis>

The mean alignment angle of the slow axis of the stretched film was determined according to the method mentioned below.

Using a polarizing microscope (Olympus's BX51), the stretched film was analyzed at regular intervals of 50 mm in the transverse direction of the film to thereby measure the in-plane slow axis of the film. The angle (alignment angle) between the slow axis direction and the transverse direction (TD) of the film was measured, and the found data were averaged to give a mean alignment angle.

The stretched film (negative birefringent film) was analyzed according to the above-mentioned methods to determine the mean alignment angle of the slow axis, the alignment angle of the tilt structure, γ, Re[0°], Rth, the temporal stability of Re and the curling resistance thereof. The data are shown in Table 2.

### [Preparation and Evaluation of Polarizer Having Stretched Film and Liquid Crystal Display Device]

Optical element (a′2) was obtained by laminating the thermoplastic resin of the invention prepared by stretching the above co-extruded film (negative birefringent film, referred to as A2 hereinafter) and a polarizer (manufactured by SANRITZ Company; HLC2-5618) in accordance with the roll-to-roll process. The angle between the slow axis of A2 and the absorption axis of the polarizer was 900.

“A positive birefringent film (B2)” was produced according to the method mentioned below. Concretely, the above resin P-2 was extruded at 260° C., and cooled and solidified on a chill roll at 130° C. according to a static charging method. The film was uniaxially stretched in the transverse direction at a temperature of 134° C., at a draw ratio of 1.35 times and at a drawing speed of 100%/min, using a tenter, thereby giving a positive birefringent film having a slow axis in the transverse direction of the film and having a width of 1.5 m and a thickness of 60 μm. The in-plane retardation Re of the film was 100 nm, and the thickness-direction retardation Rth thereof was 50 nm. This is B2.

Optical element (b′2) was obtained by laminating the positive bifefringent film (B2) and the optical element (a′2) obtained above in accordance with the roll-to-roll process. The angle between the slow axis of the positive bifefringent film (B2) and the absorption axis of optical element (a′2) was 90°. A plate obtained by cutting out of optical element (b′2) obtained above was used as polarizer of the incident side (B′2).

A polarizer at the incident side in a commercial liquid crystal display device of the in-plane switching (IPS) mode was replaced with polarizer of the incident side (B′2). The polarizer at the output side in the liquid crystal display device was replaced with a plate obtained by cutting out of the polarizer (C) laminated with the low refractive index layer and the hard coat layer which was obtained (3-4) above. The members of the liquid crystal display device were arranged in a manner such that the absorption axis of polarizer of the output side and the in-plane slow axis of the liquid crystal cell under application of no voltage were parallel to each other, and the absorption axis of polarizer of the incident side (A′2) and the in-plane slow axis of the liquid crystal cell under application of no voltage were perpendicular to each other, and a liquid crystal display device having the structure shown in FIG. 2, LCD-2, was prepared. The obtained device had a structure in which the members were disposed in the following order from the side of vision of the liquid crystal display device: the low refractive index layer, the hard coat layer, the polarizer, the liquid crystal cell, the positive birefringent film (B2), the negative birefringent film (A2), and the polarizer.

The obtained liquid crystal display device LCD-2 was kept for black expression in the entire panel, and put in a dark room. In that condition, this was watched in the front direction with the naked eye, and at an oblique angle of 60° (as measured from the normal line direction of the LCD panel). The color shift between the two was evaluated in 10 ranks of from 0 to 10 points, and the results are shown in Table 2. In this, the point “10” means the largest color shift; and the point “0” means the smallest color shift. The acceptable level from the practical point of view is at most the point “7”.

### (Preparation of TN-Mode Liquid Crystal Display Device)

The pair of polarizers set were peeled off from a liquid crystal display device having a TN-mode liquid crystal cell (AQUOS LC-20C1-S, by Sharp), and in place of them, the polarizers of Examples were set in the device in such a manner that the film of the invention produced in Example could face the liquid crystal cell via an adhesive. Each one polarizer was stuck to the device on the viewers' side and on the backlight side. However, before stuck, the film of example was forcedly aged (at (Tg−20)° C. for 20 hours). This means that the test method is equal to display evaluation after long-term use for a few years.

The entire panel was kept for white level expression, and the panel was evaluated from the frequency (from 0 to 10 points) of color shift as detected in observation in the upper oblique direction at 50°. The point “10” means that the panel entire surface had color shift; and the point “0” means that the panel had no color shift. The acceptable level from the practical point of view is at most the point “7”.

TABLE 2

| | | | | | | Physical Properties of Stretched Film | | |
|---|---|---|---|---|---|---|---|---|
| | | | | | | | Alignment Angle of Tilt | |
| | | Stretching | | | | Mean | Structure | |
| | | | | Tenter | | Alignment | Touch Roll | Chill Roll |
| | | | Chuck | Bending | Draw | Angle of | Contact | Contact |
| | Unstretched | | Speed | Angle | Ratio in | Slow Axis | Surface | Surface |
| | Film | Method | Difference % | °(degree) | Stretching | °(degree) | °(degree) | °(degree) |
| Example 101 | Example 13 | T method | — | — | 1 | 90 | 83 | −84 |
| Example 102 | Example 13 | T method | — | — | 1.05 | 0 | 82 | −82 |
| Example 103 | Example 13 | T method | — | — | 1.15 | 0 | 80 | −80 |
| Example 104 | Example 13 | T method | — | — | 1.35 | 0 | 75 | −75 |
| Example 105 | Example 13 | T method | — | — | 1.5 | 0 | 75 | −75 |
| Example 106 | Example 13 | T method | — | — | 2.4 | 0 | 84 | −84 |
| Example 107 | Example 13 | T method | — | — | 2.95 | 0 | 86 | −86 |
| Example 108 | Example 14 | N-1 method | 10 | — | 1.3 | 45 | 60 | −60 |
| Example 109 | Example 14 | N-1 method | 8 | — | 1.3 | 40 | 60 | −62 |
| Example 110 | Example 14 | N-1 method | 6 | — | 1.3 | 38 | −65 | −65 |
| Example 111 | Example 14 | N-1 method | 2 | — | 1.3 | 25 | −70 | −68 |
| Example 112 | Example 14 | N-1 method | 2 | — | 1.3 | 0 | −70 | −70 |
| Example 113 | Example 3 | N-2 method | — | 45 | 1.4 | 45 | 62 | −62 |
| Example 114 | Example 3 | N-2 method | — | 49 | 1.4 | 49 | 65 | −66 |
| Example 115 | Example 3 | N-2 method | — | 51 | 1.4 | 51 | 70 | −69 |
| Example 116 | Example 3 | N-2 method | — | 65 | 1.4 | 65 | 70 | −72 |
| Comparative | Comparative | T method | — | — | 1.35 | 0 | 90 | 90 |
| Example 101 | Example 1 | | | | | | | |
| Example 117 | Example 3 | T method | 10 | — | 1.35 | 45 | 85 | −82 |

| | | | | | | Properties of Liquid | |
|---|---|---|---|---|---|---|---|
| | Physical Properties of Stretched Film | | | | | crystal Display | |
| | | | | temporal | | Panel | |
| | γ | Re[0°] | Rth | stability of | curling | color shift | color shift |
| | nm | nm | nm | Re % | m⁻¹ | in IPS | in TN |
| Example 101 | 80 | 70 | −35 | 2 | 4 | 4 | 5 |
| Example 102 | 50 | 30 | −50 | 1 | 2 | 2 | 3 |
| Example 103 | 70 | 50 | −60 | 0 | 1 | 1 | 1 |
| Example 104 | 120 | 90 | −70 | 0 | 0 | 0 | 0 |
| Example 105 | 135 | 110 | −80 | 0 | 0 | 0 | 0 |
| Example 106 | 220 | 200 | −120 | 2 | 3 | 3 | 2 |
| Example 107 | 290 | 280 | −160 | 3 | 4 | 4 | 4 |
| Example 108 | 100 | 80 | −60 | 0 | 0 | 0 | 0 |
| Example 109 | 120 | 90 | −50 | 1 | 1 | 1 | 1 |
| Example 110 | 90 | 70 | −45 | 2 | 2 | 2 | 2 |
| Example 111 | 90 | 70 | −40 | 3 | 3 | 4 | 3 |
| Example 112 | 90 | 70 | −40 | 4 | 4 | 5 | 4 |
| Example 113 | 80 | 70 | −60 | 1 | 1 | 2 | 3 |
| Example 114 | 75 | 65 | −65 | 2 | 2.5 | 3 | 4 |
| Example 115 | 70 | 60 | −70 | 2.5 | 4 | 4 | 5 |
| Example 116 | 70 | 50 | −70 | 4 | 6 | 6 | 6 |
| Comparative | 5 | 70 | −52.5 | 7 | 15 | 10 | 10 |
| Example 101 | | | | | | | |
| Example 117 | 60 | 50 | −45 | 1 | 2 | 2 | 2 |

Examples 101 to 107 of the invention demonstrate the effect of the draw ratio in stretching; and Examples 108 to 112 and 113 to 116 of the invention demonstrates the effect of the alignment angle of the slow axis. Comparative Example 101 is the same as Example 101 in WO2005/050299; and Example 117 of the invention is modified from the Example 1 in WO2005/050299 in accordance with the invention.

The thermoplastic films of the invention exhibited good properties of temporal stability of Re and curling resistance.

In addition, the liquid crystal display devices of the invention exhibited excellent liquid crystal display characteristics (free from color shift).

### [Other Liquid Crystal Display Panels]

The films of the invention shown in Table 1 and Table 2 were used as a viewing angle compensation film, as arranged between a pair of polarizer and a liquid crystal panel. As the liquid crystal panel, ECB-mode, OCB-mode and VA-mode panels were tested with the film of the invention, and all of these enjoyed good viewing angle compensation.

The present disclosure relates to the subject matter contained in Japanese Patent Application No. 196755/2009 filed on Aug. 27, 2009, which is expressly incorporated herein by reference in its entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. A thermoplastic film having at least two thermoplastic resin layers laminated on each other, wherein at least the thermoplastic resin layer of the film surface and the thermoplastic resin layer of the film back each have a tilt structure in the thickness direction of the film, and in the plane including the tilt direction of the tilt structure and the film normal line, the sign of the angle, φ between the normal direction of the film surface and the tilt direction differs between the thermoplastic resin layer of the film surface and the thermoplastic resin layer of the film back, and wherein φ is from −90° to 90°.

2. The thermoplastic film according to claim 1, wherein the thermoplastic resin layer of the film surface and the thermoplastic resin layer of the film back each have a thickness of at least 2 μm.

3. The thermoplastic film according to claim 1, which has an interlayer having a tilt structure in the thickness direction, between the thermoplastic resin layer of the film surface and the thermoplastic resin layer of the film back.

4. The thermoplastic film according to claim 1, which satisfies the following formulae (I) and (II):
30nm≦Re[0°]≦300nm (I),
in formula (I), Re[0°] means the in-plane retardation at a wavelength of 550 nm as measured in the film normal direction;
40nm≦γ≦300nm (II),
γ=|Re[+40°]−Re[−40°]| (II)′,
in formula (II)′, Re[+40°] means the in-plane retardation at a wavelength of 550 nm, as measured in the direction tilted by 40° toward the tilt direction side relative to the normal line in the plane including the film tilt direction and the film normal line; and Re[−40°] means the in-plane retardation at a wavelength of 550 nm, as measured in the direction tilted by −40° toward the tilt direction side relative to the normal line in the plane including the film tilt direction and the film normal line.

5. The thermoplastic film according to claim 1, wherein the thermoplastic film includes a layer formed of a positive birefringent resin and a layer formed of a negative birefringent resin.

6. The thermoplastic film according to claim 5, wherein the positive birefringent resin is a cycloolefin resin.

7. The thermoplastic film according to claim 5, wherein the negative birefringent resin is a vinyl aromatic resin.

8. A method for producing a thermoplastic film, which comprises continuously nip-pressing at least two, thermoplastic resin-containing composition melt layers by leading them to run between a first nip-pressing surface and a second nip-pressing surface of a nip-pressing apparatus with applying a pressure of from 30 MPa to 500 MPa to the melt layers.

9. The method for producing a thermoplastic film according to claim 8, which further includes melt-extruding a thermoplastic resin-containing composition through a die and in which the thus melt-extruded thermoplastic resin melts are led to run between the first nip-pressing surface and the second nip-pressing surface.

10. The method for producing a thermoplastic film according to claim 8, wherein the at least two thermoplastic resin melt layers are made to have a melt viscosity difference of from 10 Pa·s to 500 Pa·s therebetween.

11. The method for producing a thermoplastic film according to claim 8, wherein the at least two thermoplastic resin melt layers are made to have a temperature difference of from 1° C. to 30° C. therebetween.

12. The method for producing a thermoplastic film according to claim 8, at least a positive birefringent resin melt and a negative birefringent resin melt are co-extruded.

13. The method for producing a thermoplastic film according to claim 8, wherein the moving speed difference between the first nip-pressing surface and the second nip-pressing surface of the nip-pressing apparatus, as defined according to the following formula, is so controlled as to be from 0.5% to 20%:
Moving Speed Difference(%)=100×{(moving speed of the first nip-pressing surface)−(moving speed of the second nip-pressing surface)}/(moving speed of the first nip-pressing surface).

14. A thermoplastic film produced by continuously nip-pressing at least two, thermoplastic resin-containing composition melt layers by leading them to run between a first nip-pressing surface and a second nip-pressing surface of a nip-pressing apparatus with applying a pressure of from 30 MPa to 500 MPa to the melt layers.

15. The thermoplastic film according to claim 14, which is produced by stretching the thermoplastic film by a tenter.

16. The thermoplastic film according to claim 14, of which the mean alignment angle of the in-plane slow axis is 45°±10°.

17. A polarizer comprising a thermoplastic film having at least two thermoplastic resin layers laminated on each other, wherein at least the thermoplastic resin layer of the film surface and the thermoplastic resin layer of the film back each have a tilt structure in the thickness direction of the film, and in the plane including the tilt direction of the tilt structure and the film normal line, the sign of the angle, φ between the normal direction of the film surface and the tilt direction differs between the thermoplastic resin layer of the film surface and the thermoplastic resin layer of the film back, and wherein φ is from −90° to 90°.

18. The polarizer according to claim 17, further having a hard coat layer.

19. A liquid crystal display device comprising a thermoplastic film having at least two thermoplastic resin layers laminated on each other, wherein at least the thermoplastic resin layer of the film surface and the thermoplastic resin layer of the film back each have a tilt structure in the thickness direction of the film, and in the plane including the tilt direction of the tilt structure and the film normal line, the sign of the angle, φ between the normal direction of the film surface and the tilt direction differs between the thermoplastic resin layer of the film surface and the thermoplastic resin layer of the film back, and wherein φ is from −90° to 90°.
